(19) United States
(12) Patent Application Publication
(10) Pub. No.: US 2017/0161628 A1
(43) Pub. Date: Jun. 8, 2017

(54) MAINTENANCE PERIOD DETERMINATION DEVICE, DETERIORATION ESTIMATION SYSTEM, DETERIORATION ESTIMATION METHOD, AND RECORDING MEDIUM

(71) Applicant: NEC CORPORATION, Tokyo (JP)

(72) Inventors: Yuki CHIBA, Minato-ku, Tokyo (JP); Yousuke MOTOHASHI, Minato-ku, Tokyo (JP); Ryohei FUJIMAKI, Minato-ku, Tokyo (JP); Satoshi MORINAGA, Minato-ku, Tokyo (JP)

(73) Assignee: NEC CORPORATION, Tokyo (JP)

(21) Appl. No.: 15/307,229

(22) PCT Filed: Apr. 15, 2015
(86) PCT No.: PCT/JP2015/002083

§ 371 Date: Oct. 27, 2016

Related U.S. Application Data
(60) Provisional application No. 61/985,237, filed on Apr. 28, 2014.

(51) Int. Cl. G06N 7/00; G06N 99/00; G06F 17/14; G06F 17/21; G06F 17/18; G06N 7/02

(52) U.S. Cl. CPC G06N 7/005; G06F 17/18; G06N 7/023; G06F 17/14; G06F 17/211; G06N 99/005

(57) ABSTRACT

An estimation data input unit 90 inputs estimation data including one or more explanatory variables which are information that may influence deterioration of an object. A component determination unit 91 determines a component to be used for estimation of deterioration of the object based on a hierarchical latent structure, which is a structure in which latent variables are represented by a tree structure and each of the components representing a probability model is assigned to each node at the lowest level of the tree structure, a gate function to determine a branch direction at each node of the hierarchical latent structure, and the estimation data. A deterioration estimation unit 92 estimates the deterioration of the object based on the component determined by the component determination unit 91 and the estimation data.

### TECHNICAL FIELD

The present invention relates to a maintenance period determination device, a maintenance period determination method, and a maintenance period determination program, and a deterioration estimation system, a deterioration estimation method, and a computer-readable recording medium in which a deterioration estimation program is recorded to estimate deterioration of various objects.

### BACKGROUND ART

Deterioration of equipment provided outside or used parts thereof can be observed using various factors and be stored as data. For example, the deterioration of equipment is caused depending on an installed period, a use frequency, weather, and the like. That is, these data are stored as observed values which are caused not by a single factor but by various factors. It is possible to analyze relationships among the installed period, the use frequency, the weather, and the like by analyzing the factors that cause such data, and accordingly, it is possible to deal with the deterioration by preventing generation of malfunction, extending service life, or appropriately grasping maintenance period.

A technique of estimating future deterioration using observation information and the like that have been collected in the past has been proposed in order to take such countermeasures (for example, PTL 1). PTL 1 discloses a method of estimating corrosion speed of a steel tower.

In addition, NPL 1 describes a method of approximating a complete marginal likelihood function to a mixture model, which is a representative example of a latent variable model, and determining types of an observation probability by maximizing its lower bound (lower limit).

### CITATION LIST

### Patent Literature

PTL 1: Japanese Patent Application Laid-Open No. 2012-13673

### Non Patent Literature

NPL 1: Ryohei Fujimaki, Satoshi Morinaga: Factorized Asymptotic Bayesian Inference for Mixture Modeling. Proceedings of the fifteenth international conference on Artificial Intelligence and Statistics (AISTATS), March 2012.

### SUMMARY OF INVENTION

### Technical Problem

PTL 1 states that a degree of fit of a model increases as explanatory variables increase, and points out that it is not necessarily good to use all explanatory variable candidates. That is, it is necessary to select explanatory variables in advance in the method described in PTL 1. It is necessary to perform such selection of explanatory variables based on knowledge of experts, and there is a problem that it is difficult to design an estimation model using such explanatory variables. In addition, there is a problem that reliability of an estimation result rather decreases when the selection of explanatory variables is inappropriate.

In addition, there is a problem that it is difficult to solve the model selection problem of a model including hierarchical latent variables even when using the method described in NPL 1. It is because it is difficult to self-evidently construct a calculation procedure since the method described in NPL 1 does not consider the hierarchical latent variables. In addition, the method described in NPL 1 is based on a strong assumption that it is hardly applied when the hierarchical latent variables are present, and thus, this method loses theoretical justification when being simply applied.

Accordingly, it is difficult to appropriately deal with the deterioration when a criterion for sorting the estimation model is inappropriate even if the deterioration of an object is grasped using these estimation methods.

An object of the present invention is to provide a maintenance period determination device, a maintenance period determination method, and a maintenance period determination program, and a deterioration estimation system, a deterioration estimation method, and a computer-readable recording medium in which a deterioration estimation program is recorded to solve the above-described problems.

### Solution to Problem

A maintenance period determination device according to the present invention is characterized by including: an estimation data input unit that inputs estimation data including one or more explanatory variables which are information that has a possibility of influencing deterioration of an object; a component determination unit that determines a component to be used for estimation of the deterioration of the object based on a hierarchical latent structure, which is a structure in which latent variables are represented by a tree structure and each of the components representing a probability model is assigned to each node at a lowest level of the tree structure, a gate function to determine a branch direction at each node of the hierarchical latent structure, and the estimation data; a deterioration estimation unit that estimates the deterioration of the object based on the component determined by the component determination unit and the estimation data; and a maintenance period determination unit that determines a maintenance period of the object by adding or subtracting a period corresponding to a dispersion of an estimation error of the component, determined by the component determination unit, to or from a period at which it is estimated such that the deterioration of the object is below a reference set in advance using the estimation performed by the deterioration estimation unit.

A maintenance period determination method according to the present invention is characterized by including: inputting estimation data including one or more explanatory variables which are information that has a possibility of influencing deterioration of an object; determining a component to be used for estimation of the deterioration of the object based on a hierarchical latent structure, which is a structure in which latent variables are represented by a tree structure and each of the components representing a probability model is assigned to each node at a lowest level of the tree structure, a gate function to determine a branch direction at each node of the hierarchical latent structure, and the estimation data; estimating the deterioration of the object based on the determined component and the estimation data; and determining a maintenance period of the object by adding or subtracting a period corresponding to a dispersion of an estimation error of the component, determined by the component determination unit, to or from a period at which it is estimated such that the deterioration of the object is below a reference set in advance.

A maintenance period determination program according to the present invention is characterized by causing a computer to execute: an estimation data input process of inputting estimation data including one or more explanatory variables which are information that has a possibility of influencing deterioration of an object; a component determination process of determining a component to be used for estimation of the deterioration of the object based on a hierarchical latent structure, which is a structure in which latent variables are represented by a tree structure and each of the components representing a probability model is assigned to each node at a lowest level of the tree structure, a gate function to determine a branch direction at each node of the hierarchical latent structure, and the estimation data; a deterioration estimation process of estimating the deterioration of the object based on the component determined in the component determination process and the estimation data; and a maintenance period determination process of determining a maintenance period of the object by adding or subtracting a period corresponding to a dispersion of an estimation error of the component, determined by the component determination unit, to or from a period at which it is estimated such that the deterioration of the object is below a reference set in advance from the estimation performed by the deterioration estimation unit.

A deterioration estimation system according to the present invention is characterized by including: a learning data input unit that inputs learning data including a plurality of combinations between an objective variable representing deterioration of an object and one or more explanatory variables which are information that may influence the deterioration of the object; a hierarchical latent structure setting unit that sets a hierarchical latent structure as a structure in which latent variables are represented by a tree structure and each of the components representing a probability model is assigned to each node at the lowest level of the tree structure; a variational probability calculation unit that calculates a variational probability of a path latent variable which is the latent variable included in a path obtained by connecting a root node to a target node in the hierarchical latent structure based on the learning data input from the learning data input unit and the component; a component optimization processing unit that optimizes the component with respect to the calculated variational probability based on the learning data input from the learning data input unit; a gate function optimization unit that optimizes a gate function model, which is a model to determine a branch direction in accordance with the explanatory variable at each node of the hierarchical latent structure, based on a latent variable variational probability of the node; an estimation data input unit that inputs one or more of the explanatory variables as estimation data; a component determination unit that determines a component to be used for estimation of the deterioration of the object among the components optimized by the component optimization processing unit based on the gate function optimized by the gate function optimization unit and the estimation data; and a deterioration estimation unit that estimates the deterioration of the object based on the component determined by the component determination unit and the estimation data.

A deterioration estimation method according to the present invention is characterized by including: inputting learning data including a plurality of combinations between an objective variable representing deterioration of an object and one or more explanatory variables which are information that may influence the deterioration of the object; setting a hierarchical latent structure as a structure in which latent variables are represented by a tree structure and each of the components representing a probability model is assigned to each node at the lowest level of the tree structure; calculating a variational probability of a path latent variable which is the latent variable included in a path obtained by connecting a root node to a target node in the hierarchical latent structure based on the input learning data and the component; optimizing the component with respect to the calculated variational probability based on the input learning data; optimizing a gate function model, which is a model to determine a branch direction in accordance with the explanatory variable at each node of the hierarchical latent structure, based on a latent variable variational probability of the node; inputting one or more of the explanatory variables as estimation data; determining a component to be used for estimation of the deterioration of the object among the optimized components based on the optimized gate function and the estimation data; and estimating the deterioration of the object based on the determined component and the estimation data.

A computer-readable recording medium in which a deterioration estimation program according to the present invention is recorded, is characterized by including the recorded deterioration estimation program that causes a computer to execute: a learning data input process that inputs learning data including a plurality of combinations between an objective variable representing deterioration of an object and one or more explanatory variables which are information that may influence the deterioration of the object; a hierarchical latent structure setting process that sets a hierarchical latent structure as a structure in which latent variables are represented by a tree structure and each of the components representing a probability model is assigned to each node at the lowest level of the tree structure; a variational probability calculation process that calculates a variational probability of a path latent variable which is the latent variable included in a path obtained by connecting a root node to a target node in the hierarchical latent structure based on the learning data input in the learning data input process and the component; a component optimization process that optimizes the component with respect to the calculated variational probability based on the learning data input in the learning data input unit; a gate function optimization process that optimizes a gate function model, which is a model to determine a branch direction in accordance with the explanatory variable at each node of the hierarchical latent structure, based on a latent variable variational probability of the node; an estimation data input process that inputs one or more of the explanatory variables as estimation data; a component determination process that determines a component to be used for estimation of the deterioration of the object among the components optimized in the component optimization process based on the gate function optimized in the gate function optimization process and the estimation data; and a deterioration estimation process that estimates the deterioration of the object based on the component determined in the component determination process and the estimation data.

### Advantageous Effects of Invention

According to the above-described aspects, it is possible to appropriately deal with deterioration.

### BRIEF DESCRIPTION OF DRAWINGS

FIG. 1 It depicts a block diagram illustrating a configuration example of a deterioration estimation system according to at least one exemplary embodiment.

FIGS. 2(A) to 2(D) They depict diagrams illustrating examples of information to be stored in a learning database according to at least one exemplary embodiment.

FIG. 3 It depicts a block diagram illustrating a configuration example of a hierarchical latent variable model estimation device according to at least one exemplary embodiment.

FIG. 4 It depicts a block diagram illustrating a configuration example of a hierarchical latent variable variational probability calculation processing unit according to at least one exemplary embodiment.

FIG. 5 It depicts a block diagram illustrating a configuration example of a gate function optimization processing unit according to at least one exemplary embodiment.

FIG. 6 It depicts a flowchart illustrating an operation example of the hierarchical latent variable model estimation device according to at least one exemplary embodiment.

FIG. 7 It depicts a flowchart illustrating an operation example of the hierarchical latent variable variational probability calculation processing unit according to at least one exemplary embodiment.

FIG. 8 It depicts a flowchart illustrating an operation example of the gate function optimization processing unit according to at least one exemplary embodiment.

FIG. 9 It depicts a block diagram illustrating a configuration example of a deterioration estimation device according to at least one exemplary embodiment.

FIG. 10 It depicts a flowchart illustrating an operation example of the deterioration estimation device according to at least one exemplary embodiment.

FIG. 11 It depicts a block diagram illustrating a configuration example of a hierarchical latent variable model estimation device according to at least one exemplary embodiment.

FIG. 12 It depicts a block diagram illustrating a configuration example of a hierarchical latent structure optimization processing unit according to at least one exemplary embodiment.

FIG. 13 It depicts a flowchart illustrating an operation example of the hierarchical latent variable model estimation device according to at least one exemplary embodiment.

FIG. 14 It depicts a flowchart illustrating an operation example of the hierarchical latent structure optimization processing unit according to at least one exemplary embodiment.

FIG. 15 It depicts a block diagram illustrating a configuration example of a gate function optimization processing unit according to a third exemplary embodiment.

FIG. 16 It depicts a flowchart illustrating an operation example of the gate function optimization processing unit according to at least one exemplary embodiment.

FIG. 17 It depicts a block diagram illustrating a configuration example of a deterioration estimation device according to at least one exemplary embodiment.

FIG. 18 It depicts a flowchart illustrating an operation example of the deterioration estimation device according to at least one exemplary embodiment.

FIG. 19 It depicts a block diagram illustrating a configuration example of a deterioration estimation device according to at least one exemplary embodiment.

FIG. 20 It depicts a block diagram illustrating a basic configuration of a maintenance period determination device.

FIG. 21 It depicts a block diagram illustrating a basic configuration of the deterioration estimation system.

FIG. 22 It depicts a schematic block diagram illustrating a configuration of a computer according to at least one exemplary embodiment.

### DESCRIPTION OF EMBODIMENTS

In the present specification, a hierarchical latent variable model indicates a model in which latent variables (that is, a hierarchical structure) have a tree structure. A component of a probability model is assigned to a lowest-level node of the tree structure. In addition, a gate function, which selects a branch depending on input, is provided in each branch node. In the following description, a hierarchical latent variable model of depth 2 will be particularly described in detail.

In addition, the hierarchical structure assumes the tree structure, and thus, a single route is determined from a root node to a certain node. Hereinafter, a route (link), obtained by connecting the root node and a certain node in the hierarchical latent structure, will be referred to as a path. In addition, a path latent variable is determined by tracing a latent variable for each path. For example, a lowest-level path latent variable indicates a path latent variable that is determined for a path from the root node to the lowest-level node.

In addition, it is assumed that a data string xⁿ (n=1, . . . , N) is input and each of xⁿ is an M-dimensional multivariate data string (xⁿ=x₁ⁿ, . . . , x_{M}ⁿ) in the following description. In addition, the data string xⁿ will be referred to also as an observation variable. A first-level branch latent variable zᵢⁿ, a lowest-level branch latent variable zⱼₗᵢⁿ, and a lowest-level path latent variable zᵢⱼⁿ with respect to the observation variable xⁿ.

The case of “zᵢⁿ=1” indicates that xⁿ input to the root node is branched out to a first-level i-th node, and the case of “zᵢⁿ=0” indicates that xⁿ is not branched out to the first-level i-th node. The case of “zⱼₗᵢⁿ=1” indicates that xⁿ, input to the first-level i-th node, is branched to a second-level j-th node, and the case of “zⱼₗᵢⁿ=0” indicates that xⁿ, input to the first-level i-th node, is not branched to the second-level j-th node. The case of “zᵢⱼⁿ=1” indicates that xⁿ corresponds to a component that is traced by passing through the first-level i-th node and the second-level j-th node, and the case of “zᵢⱼⁿ=0” indicates that xⁿ does not correspond to the component that is traced by passing through the first-level i-th node and the second-level j-th node.

Incidentally, Σᵢzᵢⁿ=1, Σⱼzⱼₗᵢⁿ=1, and zᵢⱼⁿ=zᵢⁿ·zⱼₗᵢⁿ are satisfied, and accordingly, zᵢⁿ=Σⱼzᵢⱼⁿ is established. A pair of x and a representative value z of a lowest-level path latent variable zᵢⱼⁿ is referred to as a “complete variable”. Meanwhile, x is referred to as an incomplete variable for comparison.

The hierarchical latent variable model simultaneous distribution of depth 2 relating to the complete variable is expressed by the following Formula 1.

$$\begin{matrix} [ Mathematical Formula 1 ] & \\ \begin{matrix}p ( {x}^{N} , {z}^{N} \vert M ) = p ( {x}^{N} , {z}_{1 st}^{N} , {z}_{2 nd}^{N} \vert M ) \\ = \int {\prod }_{n = 1}^{N} \{ \begin{matrix}p ( {z}_{1 st}^{n} \vert β ) {\prod }_{i = 1}^{{K}_{1}} {p ( {z}_{2 nd \vert i}^{n} \vert {β}_{i} )}^{{z}_{i}^{n}} \\ {\prod }_{i = 1}^{{K}_{1}} {\prod }_{j = 1}^{{K}_{2}} {p ( {x}^{n} \vert {φ}_{ij} )}^{{z}_{i}^{n} \cdot {z}_{j \vert i}^{n}}\end{matrix} \} d θ\end{matrix} & Formula 1\end{matrix}$$

That is, the hierarchical latent variable model simultaneous distribution of depth 2 relating to the complete variable is defined as P(x, y)=P(x, z₁ₛₜ, z_{2nd}) included in Formula 1 present as above. Herein, a representative value of zᵢⁿ is set to z₁ₛₜⁿ, and a representative value of zⱼₗᵢⁿ is set to z_{2nd}ⁿ. Incidentally, a variational distribution with respect to the first-level branch latent variable zᵢⁿ is set to q(zᵢⁿ), and a variational distribution with respect to the lowest-level path latent variable zᵢⱼⁿ is set to q(zᵢⱼⁿ).

In the above-described Formula 1, K₁ indicates the number of first-level nodes, and K₂ indicates the number of nodes that are branched out from each of the first-level nodes. A lowest-level component is indicated by K₁·K₂. In addition, θ=(β, β1, . . . , βK₁, φ1, . . . , and φK₁·K₂) indicates a parameter of a model. Meanwhile, β is branch parameter of the root node, βk is a branch parameter of a first-level k-th node, and φk is an observation parameter with respect to a k-th component.

In addition, S1, . . . , and SK₁·K₂, indicate types of an observation probability corresponding to φk. Incidentally, examples of candidates that can be S1 to SK₁·K₂ include {normal distribution, lognormal distribution, and exponential distribution} in the case of multivariate data generation probability, for example. In addition, when a polynomial curve is output, for example, examples of candidates that can be S1 to SK₁·K₂ include {zero-order curve, first-order curve, second-order curve, and third-order curve}.

Incidentally, the hierarchical latent variable model of depth 2 will be exemplified in the case of describing a specific example in the following description. However, the hierarchical latent variable model according to at least one exemplary embodiment is not limited to the hierarchical latent variable model of depth 2 and may be defined as a hierarchical latent variable model of depth 1 or 3 or more. In this case, the above-described Formula 1, and Formulas 2 to 4, which will be described later, may be also derived out similarly to the case of the hierarchical latent variable model of depth 2, and an estimation device is realized using the same configuration.

In addition, a description will be given regarding distribution of a case in which an objective variable is set to X as follows. Meanwhile, the invention can also be applied to a case, such as regression and discriminant, in which an observation distribution is a conditional model P (Y|X) (Y is a random variable serving as a target).

In addition, an essential difference between an estimation device according to exemplary embodiments and the estimation method for a mixture latent variable model described in NPL 1 will be described before describing the exemplary embodiments.

The method disclosed in NPL 1 assumes a general mixture model having the latent variable as an indicator for each component, and an optimization criterion is derived as present in Formula 10 of NPL 1. However, the method described in NPL 1 assumes that the probability distribution of the latent variable serving as the indicator for each component depends only on a mixture ratio in the mixture model as a Fisher information matrix is given as a form of Formula 6 in NPL 1. Thus, the component is hardly switched in accordance with input, and this optimization criterion is inappropriate.

To solve this problem, it is necessary to set hierarchical latent variables and perform calculation using an appropriate optimization criterion, as will be described in the following exemplary embodiments. The following exemplary embodiments assume a multi-level singular model, which selects branches for respective branch nodes in accordance with input, as an appropriate optimization criterion.

Hereinafter, exemplary embodiments will be described with reference to the accompanying drawings.

### First Exemplary Embodiment

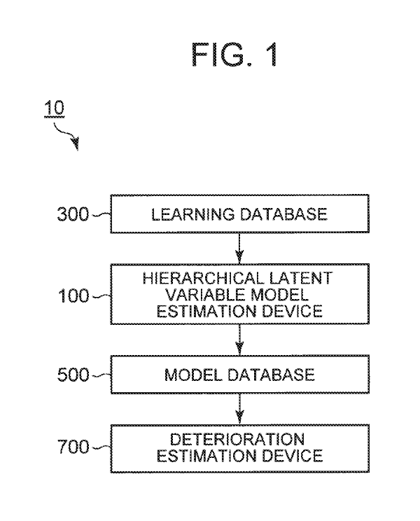

FIG. 1 is a block diagram illustrating a configuration example of a deterioration estimation system according to at least one exemplary embodiment. A deterioration estimation system 10 according to this exemplary embodiment is provided with a hierarchical latent variable model estimation device 100, a learning database 300, a model database 500, and the deterioration estimation device 700. The deterioration estimation system 10 generates a model to be used for estimation of deterioration based on observation information, which has been collected in the past, and performs the estimation of deterioration using the model.

The hierarchical latent variable model estimation device 100 estimates a model to estimate deterioration of an object using data stored in the learning database 300, and records the model in the model database 500.

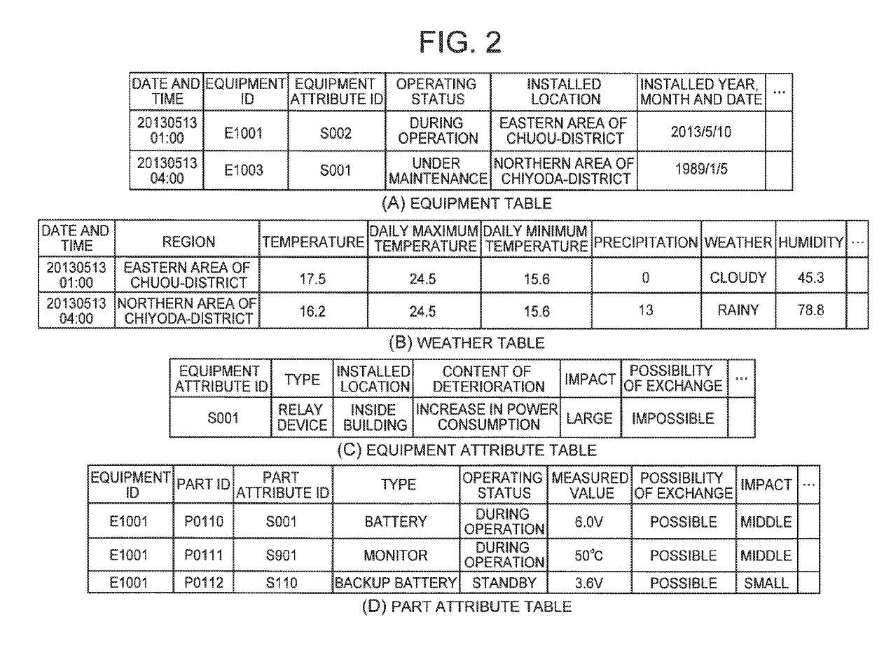

FIGS. 2(A) to 2(D) are diagrams illustrating examples of information to be stored in the learning database 300 according to at least one exemplary embodiment. The observation information and information relating to equipment are stored in the learning database 300.

To be specific, an equipment table including data relating to target equipment may be stored in the learning database 300. As illustrated in FIG. 2(A), an operating status (constant, regular, under maintenance, or the like), an installed location, installed year, month and date, and the like are stored in the equipment table in association with combinations of date and time, an equipment ID, and an equipment attribute ID. The equipment ID is information to uniquely identify equipment.

In addition, a meteorological table including data relating to weather may be stored in the learning database 300. As illustrated in FIG. 2(B), temperature, a maximum temperature of the date, a minimum temperature of the date, precipitation, weather, humidity and the like are stored in the meteorological table in association with date and time, and a region.

In addition, an equipment attribute table including data relating to an attribute of equipment may be stored in the learning database 300. As illustrated in FIG. 2(C), a type of equipment, an installed location, content of deterioration, impact at the time of malfunction, a possibility of replacement, and the like are stored in the equipment attribute table in association with each of the equipment attributes ID.

In addition, a part attribute table including data relating to an attribute of a part included in equipment may be stored in the learning database 300. As illustrated in FIG. 2(D), a type and an operating status of a part, measured values (a size, temperature, a power value, and the like), which can be measured for each part provided in the equipment, a possibility of replacement, a degree of impact at the time of malfunction, and the like are stored in the part attribute table in association with the equipment ID, a part ID, and a part attribute ID.

In addition, a time-series data table of the measured values (the size, the temperature, the power value, and the like), which can be measured for each part provided in the equipment, may be stored in the learning database 300. For example, values, which are obtained by measuring the measured values that can be measured for a part for each certain period of time, are stored in the time-series data table in association with the equipment ID, the part ID, and the like. Further, there may be a plurality of types of the measured values that can be measured for each part.

The model to estimate the deterioration of the object, which has been estimated by the hierarchical latent variable model estimation device, is stored in the model database 500. The model database 500 is configured using a tangible medium which is not temporary such as a hard disk drive and a solid state drive.

The deterioration estimation device 700 to which data relating to the observation information of the object is input estimates the deterioration of the object based on the data and the model that is stored in the model database 500.

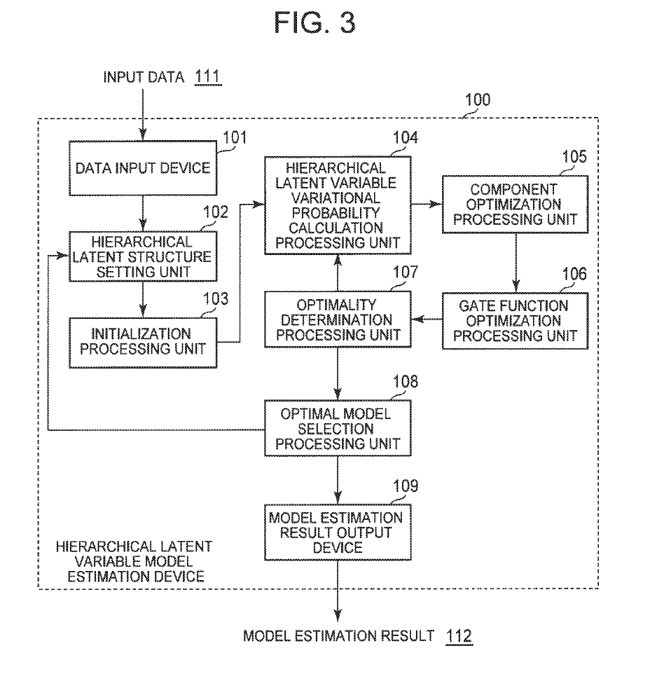

FIG. 3 is a block diagram illustrating a configuration example of a hierarchical latent variable model estimation device according to at least one exemplary embodiment. The hierarchical latent variable model estimation device 100 according to this exemplary embodiment is provided with a data input device 101, a hierarchical latent structure setting unit 102, an initialization processing unit 103, a hierarchical latent variable variational probability calculation processing unit 104, a component optimization processing unit 105, a gate function optimization processing unit 106, an optimality determination processing unit 107, an optimal model selection processing unit 108, and a model estimation result output device 109.

When input data 111 created based on the data stored in the learning database 300 is input, the hierarchical latent variable model estimation device 100 optimizes the hierarchical latent structure and the types of the observation probability for the input data 111, and outputs and records an optimized result, as a model estimation result 112, in the model database 500. The input data 111 of this exemplary embodiment is an example of learning data.

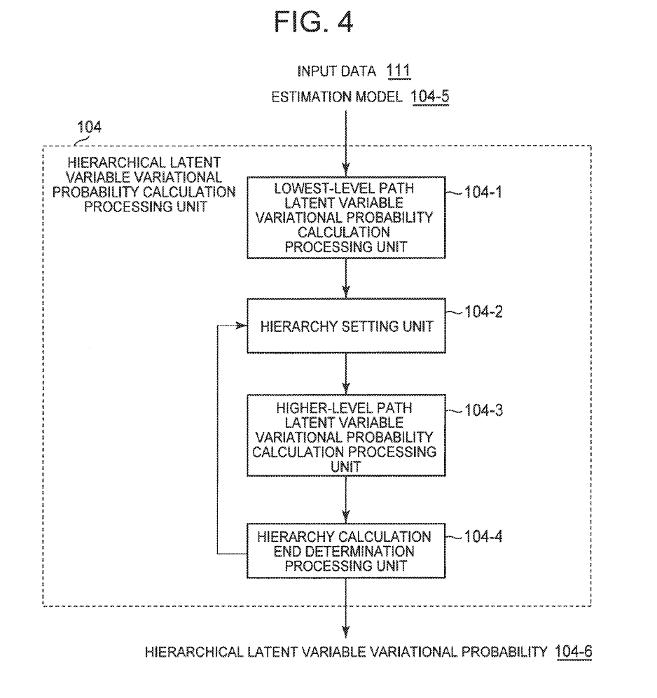

FIG. 4 is a block diagram illustrating a configuration example of the hierarchical latent variable variational probability calculation processing unit 104 according to at least one exemplary embodiment. The hierarchical latent variable variational probability calculation processing unit 104 includes a lowest-level path latent variable variational probability calculation processing unit 104-1, a hierarchy setting unit 104-2, a higher-level path latent variable variational probability calculation processing unit 104-3, and a hierarchy calculation end determination processing unit 104-4.

When the input data 111 and an estimation model 104-5, which is estimated by the component optimization processing unit 105 to be described later, are input, the hierarchical latent variable variational probability calculation processing unit 104 outputs a hierarchical latent variable variational probability 104-6. Incidentally, the hierarchical latent variable variational probability calculation processing unit 104 will be described in detail later. The component of this exemplary embodiment is a value which indicates a weight applied to each explanatory variable. The deterioration estimation device 700 can obtain an objective variable by calculating a total sum of the explanatory variables each of which is multiplied by the weight indicated by the component.

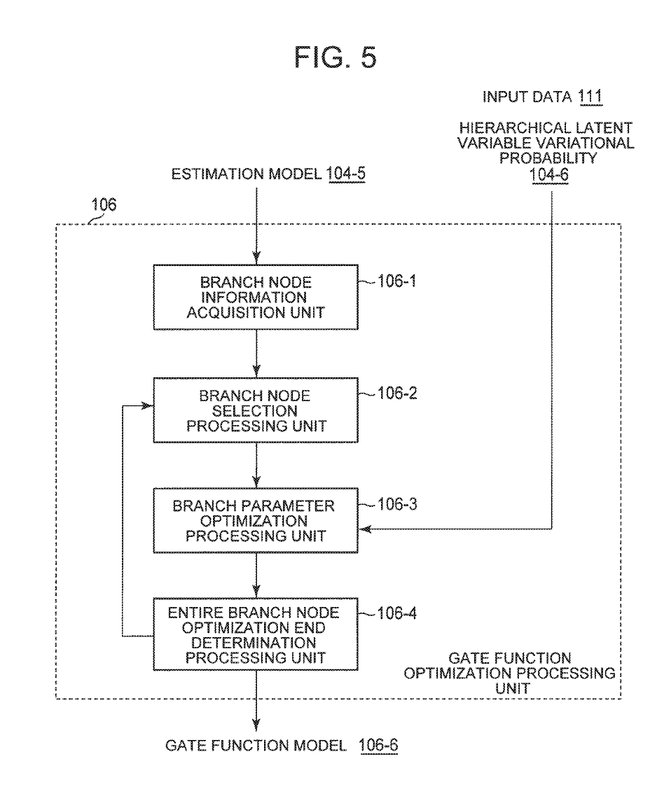

FIG. 5 is a block diagram illustrating a configuration example of the gate function optimization processing unit 106 according to at least one exemplary embodiment. The gate function optimization processing unit 106 includes a branch node information acquisition unit 106-1, a branch node selection processing unit 106-2, a branch parameter optimization processing unit 106-3, and an entire branch node optimization end determination processing unit 106-4.

When the input data 111, the hierarchical latent variable variational probability 104-6, which is calculated by the hierarchical latent variable variational probability calculation processing unit 104, and the estimation model 104-5, which is estimated by the component optimization processing unit 105, to be described later, are input, the gate function optimization processing unit 106 outputs a gate function model 106-6. Incidentally, the gate function optimization processing unit 106 will be described in detail later. The gate function according to this exemplary embodiment is a function configured to perform determination on whether information included in the input data 111 satisfies a predetermined condition. In addition, the gate function is provided to correspond to an internal node of the hierarchical latent structure. The deterioration estimation device 700 determines a subsequent node to be traced depending on a result of the determination of the gate function at the time of tracing nodes of the hierarchical latent structure.

The data input device 101 is a device configured to input the input data 111. The data input device 101 inputs the objective variable, which indicates deterioration of equipment serving as a target, based on data recorded in a shipment table of the learning database 300. For example, a softening degree, a corrosion degree, a remaining endurance time, or the like of each part provided in one equipment can be employed as the objective variable. In addition, the data input device 101 creates one or more of the explanatory variables, which are information that may influence the objective variable, for each of the objective variables based on data recorded in the respective tables (for example, the equipment table, the meteorological table, the equipment attribute table, and the part attribute table) of the learning database 300. Further, the data input device 101 inputs a plurality of combinations of the objective variable and the explanatory variable as the input data 111. The data input device 101 inputs parameters required for model estimation such as each candidate of a type of observation probability and the number of components at the same time when inputting the input data 111. In this exemplary embodiment, the data input device 101 is an example of a learning data input unit.

The hierarchical latent structure setting unit 102 selects and sets a structure of the hierarchical latent variable model which serves as a candidate of optimization using the input candidates of the type of observation probability and the number of components. A latent structure to be used in this exemplary embodiment is the tree structure. Hereinafter, the set number of components is indicated by C, and the formula to be used for description is set to one having the hierarchical latent variable model of depth 2 as a target. Incidentally, the hierarchical latent structure setting unit 102 may store the selected hierarchical latent variable model structure in an internal memory.

For example, when the tree structure of depth 2 is set in the binary tree model (model having a bifurcation at each branch node), the hierarchical latent structure setting unit 102 selects a hierarchical latent structure having two first hierarchy nodes and four second hierarchy nodes (lowest-level nodes in this exemplary embodiment).

The initialization processing unit 103 executes an initialization process in order to estimate the hierarchical latent variable model. The initialization processing unit 103 can execute the initialization process using a random method. For example, the initialization processing unit 103 may set the type of observation probability for each component in random, and set the parameter of each observation probability in random according to the set type. In addition, the initialization processing unit 103 may set a lowest-level path variational probability of the hierarchical latent variable in random.

The hierarchical latent variable variational probability calculation processing unit 104 calculates a variational probability of the path latent variable for each level. Herein, the parameter θ is calculated by the initialization processing unit 103 or by the component optimization processing unit 105 and the gate function optimization processing unit 106. Thus, the hierarchical latent variable variational probability calculation processing unit 104 calculates the variational probability using the value.

The hierarchical latent variable variational probability calculation processing unit 104 obtains a Laplace approximation of a marginal log-likelihood function with respect to an estimator (for example, a maximum likelihood estimator or a maximum posterior probability estimator) for the complete variable, and maximizes a lower bound thereof to calculate the variational probability. Hereinafter, the variational probability calculated in the above manner will be referred to as an optimization criterion A.

A procedure of calculating the optimization criterion A will be described with the example of a hierarchical latent variable model of depth 2. The marginal log-likelihood function is expressed by the following Formula 2.

$$\begin{matrix}[ Mathematical Formula 2 ] & \\ log p ( {x}^{N} \vert M ) \geq {\sum }_{{z}^{N}} q ( {z}^{N} ) log \{ \frac{p ( {x}^{N} , {z}^{N} \vert M )}{q ( {z}^{N} )} \} & Formula 2\end{matrix}$$

First, the lower bound of the marginal log-likelihood function expressed by the above-described Formula 2 will be considered. In Formula 2, the equality holds true when the lowest-level path latent variable variational probability q(zⁿ) is maximized. Herein, when a Laplace approximation of the marginal likelihood of the complete variable of the numerator is performed using a maximum likelihood estimator for the complete variable, an approximate formula of the marginal log-likelihood function, which is present in Formula 3, is obtained.

$$\begin{matrix} [ Mathematical Formula 3 ] & \\ 𝒥 ( q , \overline{θ} , {x}^{N} ) = {\sum }_{{z}^{N}} q ( {z}^{N} ) \{ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} log ( {\sum }_{n = 1}^{N} {\sum }_{j = 1}^{{K}_{2}} {z}_{ij}^{n} ) - {\sum }_{i = 1}^{{K}_{1}} {\sum }_{j = 1}^{{K}_{2}} \frac{{D}_{{φ}_{ij}}}{2} log ( {\sum }_{n = 1}^{N} {z}_{ij}^{n} ) - log q ( {z}^{N} ) \} & Formula 3\end{matrix}$$

In Formula 3, the superscript bar indicates the maximum likelihood estimator for the complete variable, and D*is a dimension of a subscript parameter *.

Next, the lower bound in Formula 3 is calculated as the following Formula 4 when using the facts that the maximum likelihood estimator has a property of maximizing the log-likelihood function and that the log function is the concave function.

$$\begin{matrix} [ Mathematical Formula 4 ] & \\ 𝒢 ( q , {q}^{′} , {q}^{″} , θ , {x}^{N} ) = {\sum }_{{z}^{N}} q ( {z}^{N} ) [ log p ( {x}^{N} , {z}^{N} \vert \overline{θ} ) - \frac{{D}_{β}}{2} log N - {\sum }_{i = 1}^{{K}_{1}} \frac{{D}_{{β}_{i}}}{2} \{ log ( {\sum }_{n = 1}^{N} {q}^{′} ( {z}_{i}^{N} ) ) + \frac{{\sum }_{n = 1}^{N} {\sum }_{j = 1}^{{K}_{2}} {z}_{ij}^{n}}{{\sum }_{n = 1}^{N} {q}^{′} ( {z}_{i}^{n} )} - 1 \} - {\sum }_{i = 1}^{{K}_{1}} {\sum }_{j = 1}^{{K}_{2}} \frac{{D}_{{φ}_{ij}}}{2} \{ log ( {\sum }_{n = 1}^{N} {q}^{″} ( {z}_{ij}^{n} ) ) + \frac{{\sum }_{n = 1}^{N} {z}_{ij}^{n}}{{\sum }_{n = 1}^{N} {q}^{″} ( {z}_{ij}^{n} )} - 1 \} - log q ( {z}^{N} ) ] & Formula 4\end{matrix}$$

A variational distribution q′ of the first-level branch latent variable, and a variational distribution q″ of the lowest-level path latent variable are obtained by maximizing Formula 4 for each of the variational distributions. Incidentally, it is fixed such that q″=q^{(t-1)} and θ=θ^{(t-1)}, and q′ is fixed to a value present in Formula A, herein.

q′=Σ^{k2}_{j=iq}^{(t-1)} (Formula A)

Meanwhile, a superscript (t) indicates a t-th repetition in repetitive calculation of the hierarchical latent variable variational probability calculation processing unit 104, the component optimization processing unit 105, the gate function optimization processing unit 106, and the optimality determination processing unit 107.

Next, an operation of the hierarchical latent variable variational probability calculation processing unit 104 will be described with reference to FIG. 4.

The lowest-level path latent variable variational probability calculation processing unit 104-1 inputs the input data 111 and the estimation model 104-5 to calculate a lowest-level latent variable variational probability q(z^{N}). The hierarchy setting unit 104-2 sets a target for which the variational probability is to be calculated is the lowest-level. To be specific, the lowest-level path latent variable variational probability calculation processing unit 104-1 calculates each variational probability of the estimation models 104-5 for each combination between the objective variable and the explanatory variable of the input data 111. The calculation of the variational probability is performed by comparing a solution obtained by substituting the explanatory variable of the input data 111 into the estimation model 104-5 with the objective variable of the input data 111.

The higher-level path latent variable variational probability calculation processing unit 104-3 calculates a path latent variable variational probability of an immediately higher level. To be specific, the higher-level path latent variable variational probability calculation unit 104-3 calculates a sum of latent variable variational probabilities of the current level having the same branch node as a parent and sets a value of the sum as the path latent variable variational probability of the immediately higher level.

The hierarchy calculation end determination processing unit 104-4 determines whether any higher level for which the variational probability is to be calculated is present. When it is determined that there is a higher level, the hierarchy setting unit 104-2 sets an immediately higher level for which the variational probability is to be calculated. Thereafter, the higher-level path latent variable variational probability calculation processing unit 104-3 and the hierarchy calculation end determination processing unit 104-4 repeat the above-described processes. On the contrary, the hierarchy calculation end determination processing unit 104-4 determines that the path latent variable variational probabilities have been calculated for the entire hierarchy when it is determined that there is no higher level.

The component optimization processing unit 105 optimizes the model of each component (the parameter θ and a type S thereof) with respect to the above-described Formula 4 and outputs the optimized estimation model 104-5. In the case of the hierarchical latent variable model of depth 2, the component optimization processing unit 105 fixes q and q″ to a lowest-level path latent variable variational probability q^{(t)} calculated by the hierarchical latent variable variational probability calculation processing unit 104, and fixes q′ to the higher-level path latent variable variational probability present in Formula A. Further, the component optimization processing unit 105 calculates a model for maximizing the value of G present in Formula 4.

G defined by the above-described Formula 4 enables decomposition of an optimization function for each component. Thus, it is possible to independently optimize S1 to SK₁·K₂ and the parameter φ1 to φK₁·K₂ without considering a combination types of components (for example, any type of S1 to SK₁·K₂ to be designated). It is an important point that it is possible to perform optimization in this manner. Accordingly, it is possible to optimize the type of the component while avoiding combinatorial explosion.

Next, an operation of the gate function optimization processing unit 106 will be described with reference to FIG. 5. The branch node information acquisition unit 106-1 extracts a list of branch nodes using the estimation model 104-5 estimated in the component optimization processing unit 105. The branch node selection processing unit 106-2 selects one branch node from the extracted list of branch nodes. Hereinafter, the selected node will be referred to as a selection node in some cases.

The branch parameter optimization processing unit 106-3 optimizes the branch parameter of the selection node using the input data 111 and the latent variable variational probability relating to the selection node obtained from the hierarchical latent variable variational probability 104-6. Incidentally, the branch parameter of the selection node corresponds to the above-described gate function.

The entire branch node optimization end determination processing unit 106-4 determines whether all branch nodes extracted by the branch node information acquisition unit 106-1 have been optimized. When all the branch nodes have been optimized, the gate function optimization processing unit 106 ends the process here. On the contrary, the process according to the branch node selection unit 106-2 is performed when all branch nodes have not been optimized, and thereafter, the processes according to the branch parameter optimization processing unit 106-3 and the entire branch node optimization end determination unit 106-4 are performed.

Here, a specific example of the gate function will be described with an example based on the Bernoulli distribution for the binary tree hierarchy model. Hereinafter, a gate function based on the Bernoulli distribution will be referred to as a “Bernoulli gate function” in some cases. Herein, a d-th dimension of x is set to x_{d}, and a probability to be branched to a lower left branch of the binary tree when this value does not exceed a threshold w is set to g⁻, and a probability to be branched to the lower left branch of the binary tree when this value exceeds a threshold w is set to g⁺. The branch parameter optimization processing unit 106-3 optimizes the above-described optimization parameter d, w, g⁻, and g⁺ based on the Bernoulli distribution. This enables more rapid optimization since each parameter has an analytic solution, which is different from a gate function based on the logit function described in NPL 1.

The optimality determination processing unit 107 determines whether the optimization criterion A, calculated using the above-described Formula 4, has converged. When the optimization criterion A has not converged, the processes according to the hierarchical latent variable variational probability calculation processing unit 104, the component optimization processing unit 105, the gate function optimization processing unit 106, and the optimality determination processing unit 107 are repeated. The optimality determination processing unit 107 may determine that the optimization criterion A has converged when an increment of the optimization criterion A is smaller than a predetermined threshold, for example.

Hereinafter, the processes according to the hierarchical latent variable variational probability calculation processing unit 104, the component optimization processing unit 105, the gate function optimization processing unit 106, and the optimality determination processing unit 107 will be referred to collectively as processes according to the hierarchical latent variable variational probability calculation processing unit 104 through the optimality determination processing unit 107, in some cases. An appropriate model can be selected by repeating the processes according to the hierarchical latent variable variational probability calculation processing unit 104 through the optimality determination processing unit 107 and updating the variational distribution and the model. Incidentally, a monotonic increase of the optimization criterion A is guaranteed by repeating these processes.

The optimal model selection processing unit 108 selects an optimal model. To be specific, when the optimization criterion A calculated using the processes according to the hierarchical latent variable variational probability calculation processing unit 104 through the optimality determination processing unit 107 is larger than the currently set optimization criterion A with respect to the number C of latent states set by the hierarchical latent structure setting unit 102, the optimal model selection processing unit 108 selects the model as an optimal model.

When the optimization of the model is completed for the candidates of the hierarchical latent variable model structure, set from the input candidates of types of the observation probability and the number of components, the model estimation result output device 109 outputs the number of optimal latent states, the type, the parameter, the variational distribution, and the like of the observation probability as an output result of the model estimation result 112. On the contrary, when a candidate for which the optimization has not been completed is present, the process transitions to the hierarchical latent structure setting unit 102, and the above-described process is performed in the same manner.

The hierarchical latent structure setting unit 102, the initialization processing unit 103, the hierarchical latent variable variational probability calculation processing unit 104 (more specifically, the lowest-level path latent variable variational probability calculation processing unit 104-1, the hierarchy setting unit 104-2, the higher-level path latent variable variational probability calculation processing unit 104-3, and the hierarchy calculation end determination processing unit 104-4), the component optimization processing unit 105, the gate function optimization processing unit 106 (more specifically, the branch node information acquisition unit 106-1, the branch node selection processing unit 106-2, the branch parameter optimization processing unit 106-3, and the entire branch node optimization end determination processing unit 106-4), the optimality determination processing unit 107, and the optimal model selection processing unit 108 are executed by a CPU of a computer that operates according to a program (estimation program of the hierarchical latent variable model).

For example, the program may be stored in a storage unit (not illustrated) of the hierarchical latent variable model estimation device 100, and the CPU may read out the program and operate as the hierarchical latent structure setting unit 102, the initialization processing unit 103, the hierarchical latent variable variational probability calculation processing unit 104 (more specifically, the lowest-level path latent variable variational probability calculation processing unit 104-1, the hierarchy setting unit 104-2, the higher-level path latent variable variational probability calculation processing unit 104-3, and the hierarchy calculation end determination processing unit 104-4), the component optimization processing unit 105, the gate function optimization processing unit 106 (more specifically, the branch node information acquisition unit 106-1, the branch node selection processing unit 106-2, the branch parameter optimization processing unit 106-3, and the entire branch node optimization end determination processing unit 106-4), the optimality determination processing unit 107, and the optimal model selection processing unit 108 according to the program.

In addition, each of the hierarchical latent structure setting unit 102, the initialization processing unit 103, the hierarchical latent variable variational probability calculation processing unit 104, the component optimization processing unit 105, the gate function optimization processing unit 106, the optimality determination processing unit 107, and the optimal model selection processing unit 108 may be implemented by dedicated hardware.

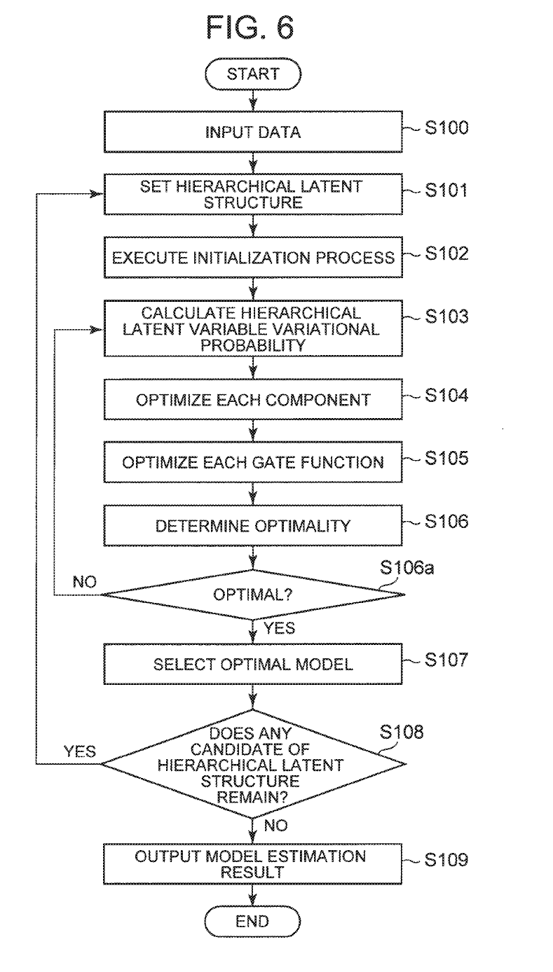

Next, an operation of the hierarchical latent variable model estimation device of this exemplary embodiment will be described. FIG. 6 is a flowchart illustrating an operation example of the hierarchical latent variable model estimation device according to at least one exemplary embodiment.

First, the data input device 101 inputs the input data 111 (step S100). Next, the hierarchical latent structure setting unit 102 selects and sets the hierarchical latent structure for which optimization has not been performed yet among candidate values of the input hierarchical latent structure (step S101). Next, the initialization processing unit 103 performs the initialization process of the parameter and the latent variable variational probability which are used for estimation with respect to the set hierarchical latent structure (step S102).

Next, the hierarchical latent variable variational probability calculation processing unit 104 calculates each variational probability of the path latent variables (step S103). Next, the component optimization processing unit 105 estimates the type and the parameter of the observation probability for each component to optimize the component (step S104).

Next, the gate function optimization processing unit 106 optimizes the branch parameter in each branch node (step S105). Next, the optimality determination processing unit 107 determines whether the optimization criterion A has converged (step S106). That is, the optimality determination processing unit 107 determines the optimality of the model.

When it is determined in step S106 that the optimization criterion A has not converged, that is, it is determined to be not optimal, (No in step S106a), the processes from step S103 to step S106 are repeated.

On the contrary, when it is determined in step S106 that the optimization criterion A has converged, that is, it is determined to be optimal (Yes in step S106a), the optimal model selection processing unit 108 compares a value of the optimization criterion A according to the currently set optimal model (for example, the number of components, the type of the observation probability, and the parameter) and a value of the optimization criterion A according to the currently set model as the optimal model, and selects the model having the larger value as the optimal model (step S107).

Next, the optimal model selection processing unit 108 determines whether any candidate of the hierarchical latent structure for which estimation has not been performed remains (step S108). When a candidate remains (Yes in step S108), the processes from step S102 to step S108 are repeated. On the contrary, when any candidate does not remain (No in step S108), the model estimation result output device 109 outputs the model estimation result and ends the process (step S109). In other words, the model estimation result output device 109 records the component optimized by the component optimization processing unit 105 and the gate function optimized by the gate function optimization processing unit 106 in the model database 500.

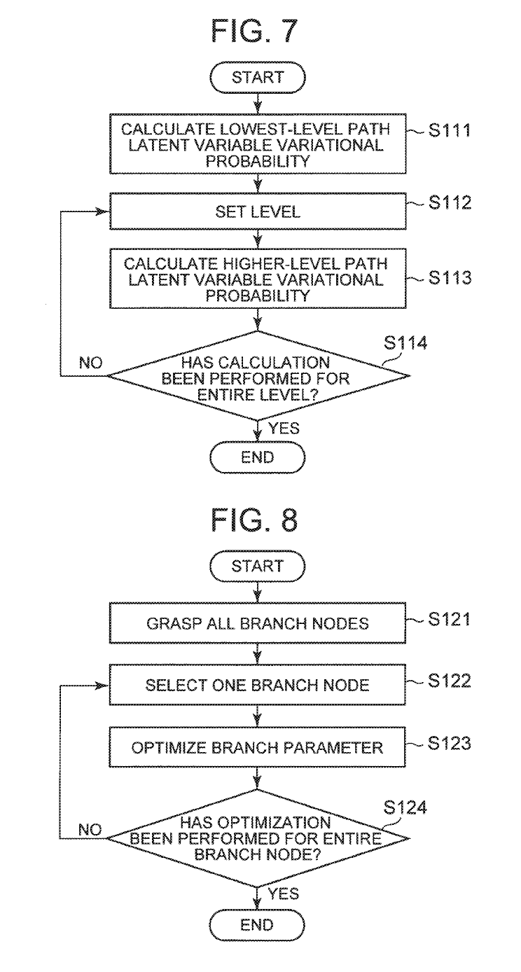

Next, the operation of the hierarchical latent variable variational probability calculation processing unit 104 of this exemplary embodiment will be described. FIG. 7 is a flowchart illustrating an operation example of the hierarchical latent variable variational probability calculation processing unit 104 according to at least one exemplary embodiment.

First, the lowest-level path latent variable variational probability calculation processing unit 104-1 calculates the lowest-level path latent variable variational probability (step S111). Next, the hierarchy setting unit 104-2 sets any level for which the path latent variable has been calculated (step S112). Next, the higher-level path latent variable variational probability calculation processing unit 104-3 calculates a path latent variable variational probability of an immediately higher level using the path latent variable variational probability of the level set by the hierarchy setting unit 104-2 (step S113).

Next, the hierarchy calculation end determination processing unit 104-4 determines whether any level for which the path latent variable has not been calculated remains (step S114). When a level for which the path latent variable has not been calculated remains (No in step S114), the processes from step S112 and step S113 are repeated. On the contrary, any level for which the path latent variable has not been calculated does not remain, the hierarchical latent variable variational probability calculation processing unit 104 ends the process.

Next, the operation of the gate function optimization processing unit 106 of this exemplary embodiment will be described. FIG. 8 is a flowchart illustrating an operation example of the gate function optimization processing unit 106 according to at least one exemplary embodiment.

First, the branch node information acquisition unit 106-1 grasps all branch nodes (step S121). Next, the branch node selection processing unit 106-2 selects one branch node as a target of optimization (step S122). Next, the branch parameter optimization processing unit 106-3 optimizes a branch parameter in the selected branch node (step S123).

Next, the entire branch node optimization end determination processing unit 106-4 determines whether any branch node that has not been optimized remains (step S124). When a branch node that has not been optimized remains, the processes from step S122 and step S123 are repeated. On the contrary, when any branch node that has not been optimized does not remain, the gate function optimization processing unit 106 ends the process.

As above, the hierarchical latent structure setting unit 102 sets the hierarchical latent structure in this exemplary embodiment. Incidentally, the hierarchical latent structure is a structure in which latent variables are represented by the tree structure, and components representing probability models are assigned to nodes at the lowest-level.

Further, the hierarchical latent variable variational probability calculation processing unit 104 calculates the variational probability (that is, the optimization criterion A) of the path latent variable. The hierarchical latent variable variational probability calculation processing unit 104 may calculate the variational probabilities of the latent variables for each level of the tree structure in the order from the lowest-level nodes. In addition, the hierarchical latent variable variational probability calculation processing unit 104 may calculate the variational probability to maximize the marginal log-likelihood function.

Further, the component optimization processing unit 105 optimizes the component with respect to the calculated variational probability, and the gate function optimization processing unit 106 optimizes the gate function model based on the latent variable variational probability in the node of the hierarchical latent structure. Incidentally, the gate function model is a model to determine a branch direction in accordance with the multivariate data in the node of the hierarchical latent structure.

Since the hierarchical latent variable model for the multivariate data is estimated using the above-described configuration, it is possible to estimate a hierarchical latent variable model including hierarchical latent variables with an appropriate amount of calculation without losing theoretical justification. In addition, when the hierarchical latent variable model estimation device 100 is used, it is unnecessary to manually set a criterion appropriate to sort components.

In addition, the hierarchical latent structure setting unit 102 may set the hierarchical latent structure in which the latent variables are represented by the binary tree structure, and the gate function optimization processing unit 106 may optimize the gate function model based on the latent variable variational probability in the node according to the Bernoulli distribution. In this case, the more rapid optimization becomes possible since each parameter has an analytic solution.

Through these processes, the hierarchical latent variable model estimation device 100 can separate the components into a deterioration pattern when an operating time is long or short, a deterioration pattern when the installed location is inside or outside the building, a deterioration pattern when a predetermined part is present or absent, and the like.

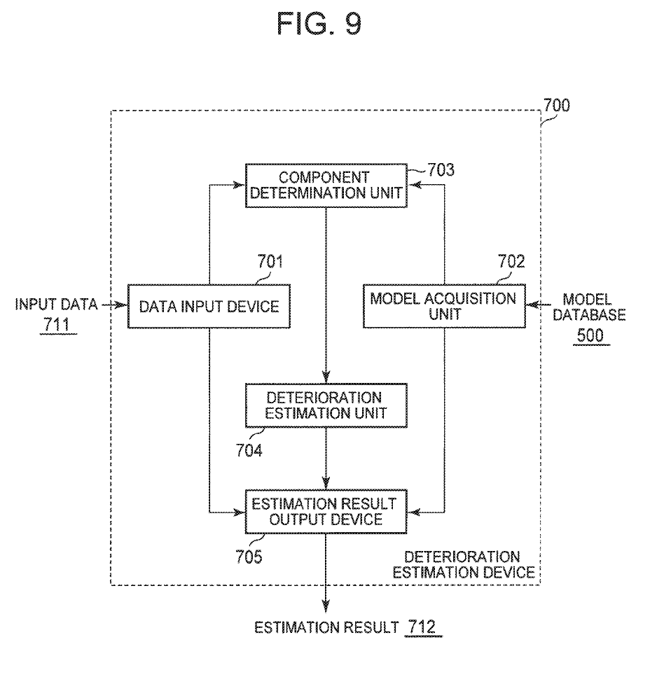

The deterioration estimation device of this exemplary embodiment will be described. FIG. 9 is a block diagram illustrating a configuration example of the deterioration estimation device according to at least one exemplary embodiment. The deterioration estimation device 700 is provided with a data input device 701, a model acquisition unit 702, a component determination unit 703, a deterioration estimation unit 704, and an estimation result output device 705.

The data input device 701 inputs one or more explanatory variables that may influence deterioration of an object as input data 711. A type of the explanatory variable included in the input data 711 may be the same type as the explanatory variable of the input data 111. In this exemplary embodiment, the data input device 701 is an example of an estimation data input unit.

The model acquisition unit 702 acquires the gate function and the component from the model database 500 as a model to be used for estimation of deterioration. The gate function is the one that is optimized by the gate function optimization processing unit 106. In addition, the component is the one that is optimized by the component optimization processing unit 105.

The component determination unit 703 traces a hierarchical latent structure based on the input data 711 input from the data input device 701 and the gate function acquired by the model acquisition unit 702. Further, the component determination unit 703 determines a component associated with a lowest-level node of the hierarchical latent structure as a component to be used for, the deterioration estimation.

The deterioration estimation unit 704 estimates deterioration by substituting the input data 711 input from the data input device 701 into the component determined by the component determination unit 703. The estimation result output device 705 outputs an estimation result 712 of deterioration obtained by the deterioration estimation unit 704.

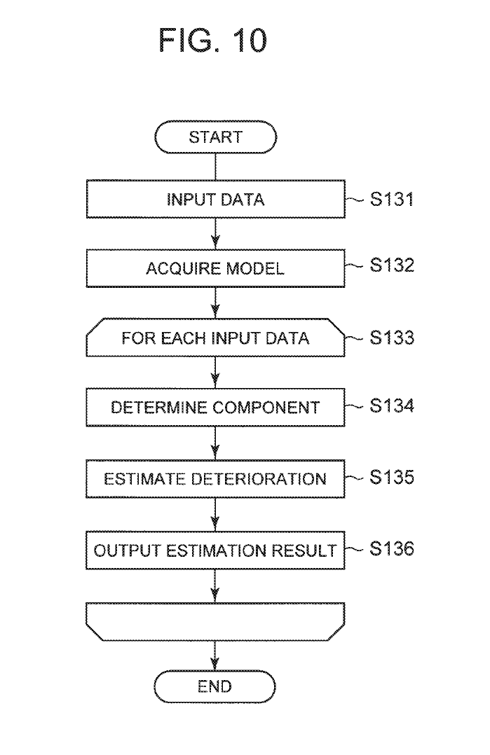

Next, an operation of the deterioration estimation device of this exemplary embodiment will be described. FIG. 10 is a flowchart illustrating an operation example of the deterioration estimation device according to at least one exemplary embodiment.

First, the data input device 701 inputs the input data 711 (step S131). Incidentally, the data input device 701 may input a plurality of the input data 711 instead of the single input data 711. For example, the data input device 701 may input the input data 711 for each time on a certain date in certain equipment. When the data input device 701 inputs the plurality of input data 711, the deterioration estimation unit 704 estimates the deterioration of the object for each of the input data 711. Next, the model acquisition unit 702 acquires the gate function and the component from the model database 500 (step S132).

Next, the deterioration estimation device 700 selects the input data 711 one by one, and executes the following processes in step S134 to step S136 for the selected input data 711 (step S133).

First, the component determination unit 703 determines the component to be used for the deterioration estimation by tracing a path from the root node to the lowest-level node in the hierarchical latent structure based on the gate function acquired by the model acquisition unit 702 (step S134). To be specific, the component determination unit 703 determines the component according to the following procedure.

The component determination unit 703 reads out a gate function associated with a node for each of the nodes in the hierarchical latent structure. Next, the component determination unit 703 determines whether the input data 711 satisfy the read gate function. Next, the component determination unit 703 determines a child node that is to be traced next based on a result of the determination. When reaching the lowest-level node after tracing the nodes in the hierarchical latent structure through the above processes, the component determination unit 703 determines the component associated with the corresponding node as the component to be used for the deterioration estimation.

When the component determination unit 703 determines the component to be used for the deterioration estimation in step S134, the deterioration estimation unit 704 estimates the deterioration of the object by substituting the input data 711 selected in step S133 into the component (step S135). Further, the estimation result output device 705 outputs the estimation result 712 of deterioration obtained by the deterioration estimation unit 704 (step S136).

Further, the deterioration estimation device 700 executes the processes in step S134 to step S136 for the entire input data 711, and ends the process.

As above, the deterioration estimation device 700 of this exemplary embodiment can perform the estimation of deterioration of the object with high accuracy using the appropriate component through the gate function. In particular, the deterioration estimation device 700 can perform the deterioration estimation using the component classified with the appropriate criteria since the gate function and the component are estimated by the hierarchical latent variable model estimation device 100 without losing theoretical justification.

### Second Exemplary Embodiment

Next, a second exemplary embodiment of the deterioration estimation system will be described. A deterioration estimation system according to this exemplary embodiment has only a difference that the hierarchical latent variable model estimation device 100 is replaced by a hierarchical latent variable model estimation device 200 as compared to the deterioration estimation system 10.

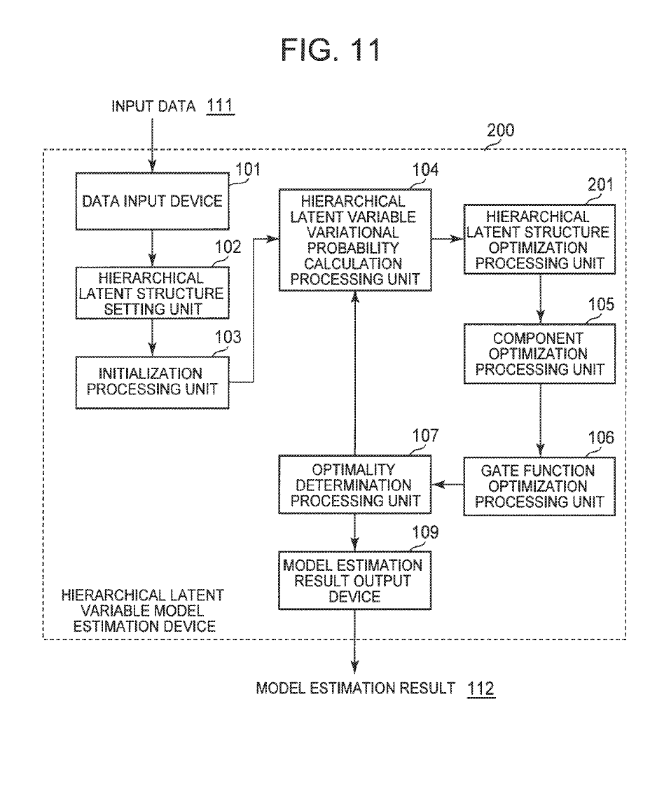

FIG. 11 is a block diagram illustrating a configuration example of the hierarchical latent variable model estimation device according to at least one exemplary embodiment. Incidentally, configurations which are the same as in the first exemplary embodiment will be denoted by the same reference signs as in FIG. 3, and the description thereof will be omitted. The hierarchical latent variable model estimation device 200 of this exemplary embodiment has only a difference of being connected with a hierarchical latent structure optimization processing unit 201 instead of being connected with the optimal model selection processing unit 108 as compared to the hierarchical latent variable model estimation device 100.

In addition, the hierarchical latent variable model estimation device 100 optimizes the model of the component or the gate function for the candidate of the hierarchical latent structure and selects the hierarchical latent structure that maximizes the optimization criterion A in the first exemplary embodiment. Meanwhile, a process of removing a path in which latent variables decrease from a model, which is performed by the hierarchical latent structure optimization processing unit 201, is added after the process according to the hierarchical latent variable variational probability calculation processing unit 104 in the hierarchical latent variable model estimation device 200 of this exemplary embodiment.

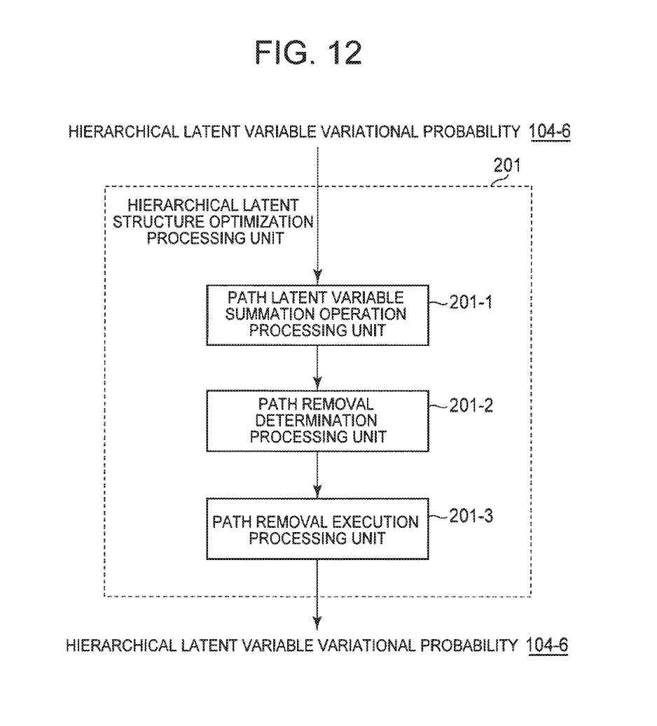

FIG. 12 is a block diagram illustrating a configuration example of the hierarchical latent structure optimization processing unit 201 according to at least one exemplary embodiment. The hierarchical latent structure optimization processing unit 201 includes a path latent variable summation operation processing unit 201-1, a path removal determination processing unit 201-2, and a path removal execution processing unit 201-3.

The path latent variable summation operation processing unit 201-1 inputs the hierarchical latent variable variational probability 104-6, and calculates a sum (hereinafter, referred to as a sample sum) of variable variational probabilities of the lowest-level path in each component.

The path removal determination processing unit 201-2 determines that the sample sum is equal to or smaller than a predetermined threshold E. Herein, c is a threshold that is input together with the input data 111. To be specific, a condition determined by the path removal determination processing unit 201-2 can be expressed by the following Formula 5, for example.

$$\begin{matrix}[ Mathematical Formula 5 ] & \\ {\sum }_{n = 1}^{N} q ( {z}_{ij}^{n} ) \leq ε & Formula 5\end{matrix}$$

That is, the path removal determination processing unit 201-2 determines whether the lowest-level path latent variable variational probability q(zᵢⱼⁿ) in each component satisfies a criterion expressed in Formula 5. In other words, it may be also described that the path removal determination processing unit 201-2 determines whether the sample sum is sufficiently small.

The path removal execution processing unit 201-3 sets a variational probability of a path for which it is determined that the sample sum is sufficiently small to zero. Further, the path removal execution processing unit 201-3 recalculates and outputs the hierarchical latent variable variational probability 104-6 at each hierarchical level using the lowest-level path latent variable variational probability that has been normalized for remaining paths (that is, paths whose variational probability is not set to be zero).

The justification of this process will be described. Formula 6, which is illustrated as follows, is an updated formula of q(zᵢⱼⁿ) in repetitive optimization.

$$\begin{matrix} [ Mathematical Formula 6 ] & \\ {q}^{t} ( {z}_{ij}^{n} ) ∝ {g}_{i}^{n} {g}_{j \vert i}^{n} p ( {x}^{n} \vert {φ}_{ij} ) exp \{ \frac{- {D}_{{β}_{i}}}{2 {\sum }_{n = 1}^{N} {\sum }_{j = 1}^{{K}_{2}} {q}^{t - 1} ( {z}_{ij}^{n} )} + \frac{- {D}_{{φ}_{ij}}}{2 {\sum }_{n = 1}^{N} {q}^{t - 1} ( {z}_{ij}^{n} )} \} & Formula 6\end{matrix}$$

In the above-described Formula 6, the exponential part includes a negative term, and q(zᵢⱼⁿ), calculated in the preceding process, serves as the denominator of the term. Accordingly, an optimized value of q(zᵢⱼⁿ) decreases as a value of this denominator decreases, and thus, it is illustrated that variational probabilities of small path latent variables gradually decrease through the repetitive calculation.

Incidentally, the hierarchical latent structure optimization processing unit 201 (more specifically, the path latent variable summation operation processing unit 201-1, the path removal determination processing unit 201-2, and the path removal execution processing unit 201-3) is implemented by a CPU of a computer that operates according to a program (estimation program of a hierarchical latent variable model).

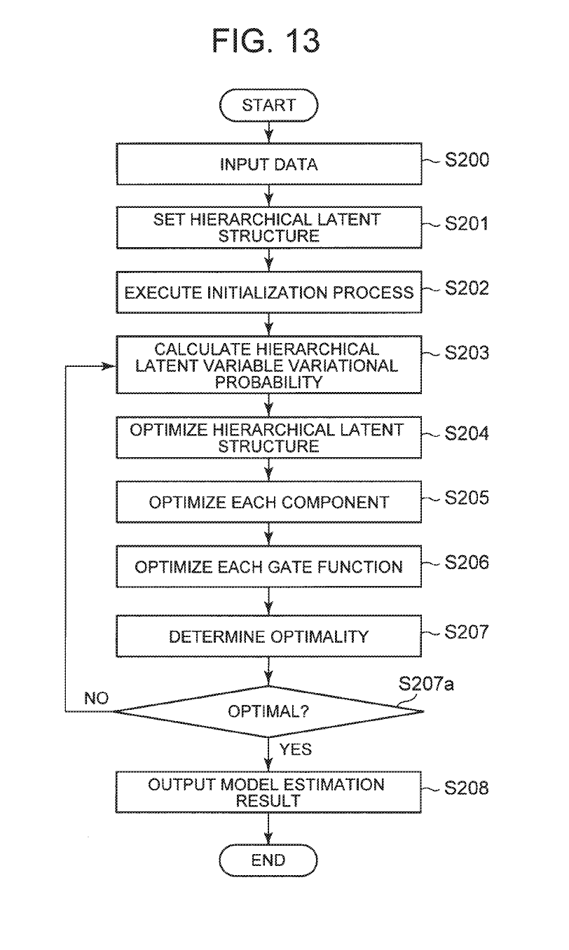

Next, an operation of the hierarchical latent variable model estimation device 200 of this exemplary embodiment will be described. FIG. 13 is a flowchart illustrating an operation example of the hierarchical latent variable model estimation device 200 according to at least one exemplary embodiment.

First, the data input device 101 inputs the input data 111 (step S200). Next, the hierarchical latent structure setting unit 102 sets an initial state of the number of latent states as a hierarchical latent structure (step S201).

That is, an optimal solution has been searched by executing all of the plurality of candidates for the number of components in the first exemplary embodiment. On the other hand, it is possible to optimize the hierarchical latent structure by a one-time process since it is also possible to optimize the number of components in the second exemplary embodiment. Accordingly, an initial value of the number of latent states may be set only once in step S201 instead of selecting a candidate for which optimization has not been executed among a plurality of candidates, as illustrated in step S102 according to the first exemplary embodiment.

Next, the initialization processing unit 103 performs an initialization process of a parameter and a latent variable variational probability which are used for estimation with respect to the set hierarchical latent structure (step S202).

Next, the hierarchical latent variable variational probability calculation processing unit 104 calculates each variational probability of the path latent variables (step S203). Next, the hierarchical latent structure optimization processing unit 201 estimates the number of components to optimize the hierarchical latent structure (step S204). That is, the hierarchical latent structure is optimized, the number of components is also optimized when the hierarchical latent structure is optimized since the components are assigned to the respective lowest-level nodes.

Next, the component optimization processing unit 105 estimates a type and a parameter of an observation probability for each component to optimize the component (step S205). Next, the gate function optimization processing unit 106 optimizes a branch parameter in each branch node (step S206). Next, the optimality determination processing unit 107 determines whether the optimization criterion A has converged (step S207). That is, the optimality determination processing unit 107 determines the optimality of the model.

When it is determined in step S207 that the optimization criterion A has not converged, that is, it is determined to be not optimal, (No in step S207a), the processes from step S203 to step S207 are repeated.

On the contrary, when it is determined in step S106 that the optimization criterion A has converged, that is, it is determined to be optimal (Yes in step S207a), the model estimation result output device 109 outputs a model estimation result and ends the process (step S208).

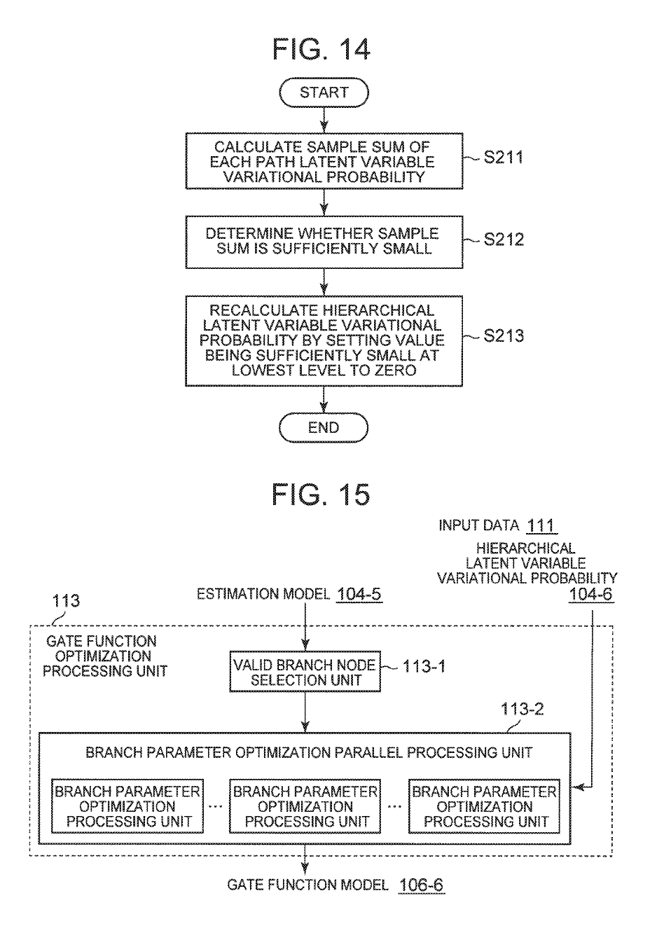

Next, an operation of the hierarchical latent structure optimization processing unit 201 of this exemplary embodiment will be described. FIG. 14 is a flowchart illustrating an operation example of the hierarchical latent structure optimization processing unit 201 according to at least one exemplary embodiment.

First, the path latent variable summation operation processing unit 201-1 calculates the sample sum of the path latent variables (step S211). Next, the path removal determination processing unit 201-2 determines whether the calculated sample sum is sufficiently small (step S212). Next, the path removal execution processing unit 201-3 recalculates and outputs a hierarchical latent variable variational probability by setting a lowest-level path latent variable variational probability for which it is determined that the sample sum is sufficiently small to zero, and ends the process (step S213).

As above, the hierarchical latent structure optimization processing unit 201 optimizes the hierarchical latent structure by removing the path having the calculated variational probability equal to or smaller than the predetermined threshold from the model in this exemplary embodiment.

Through this configuration, it is unnecessary to perform optimization for the plurality of candidates in the hierarchical latent structure as in the hierarchical latent variable model estimation device 100, and it is also possible to optimize the number of components with the one-time execution processing in addition to the effects of the first exemplary embodiment. Thus, it is possible to estimate the number of components, the type and the parameter of the observation probability, and the variational distribution at the same time, and to suppress calculation cost.

### Third Exemplary Embodiment

Next, a third exemplary embodiment of the deterioration estimation system will be described. A deterioration estimation system according to this exemplary embodiment is different from that of the second exemplary embodiment in terms of a configuration of a hierarchical latent variable model estimation device. The hierarchical latent variable model estimation device of this exemplary embodiment has only a difference that the gate function optimization processing unit 106 is replaced by a gate function optimization processing unit 113 as compared to the hierarchical latent variable model estimation device 200.

FIG. 15 is a block diagram illustrating a configuration example of the gate function optimization processing unit 113 according to the third exemplary embodiment. The gate function optimization processing unit 113 includes a valid branch node selection unit 113-1 and a branch parameter optimization parallel processing unit 113-2.

The valid branch node selection unit 113-1 selects only a valid branch node from a hierarchical latent structure. To be specific, the valid branch node selection unit 113-1 selects only the valid branch node using the estimation model 104-5 estimated by the component optimization processing unit 105 on consideration of a path that has been removed from a model. That is, the valid branch node means a branch node on a path that has not been removed from the hierarchical latent structure.

The branch parameter optimization parallel processing unit 113-2 performs optimization processes of branch parameters relating to the valid branch nodes in parallel and outputs the gate function model 106-6. To be specific, the branch parameter optimization parallel processing unit 113-2 optimizes the branch parameters relating to all the valid branch nodes in parallel at the same time using the input data 111 and the hierarchical latent variable variational probability 104-6 calculated by the hierarchical latent variable variational probability calculation processing unit 104.

The branch parameter optimization parallel processing unit 113-2 may be configured by arranging the branch parameter optimization processing units 106-3 of the first exemplary embodiment in parallel as illustrated in FIG. 15, for example. Through this configuration, it is possible to optimize the branch parameters of the entire gate function at once.

That is, although the hierarchical latent variable model estimation devices 100 and 200 execute the optimization processes of the gate functions one by one, the hierarchical latent variable model estimation device of this exemplary embodiment can perform the optimization processes of the gate functions in parallel, which enables the more rapid model estimation.

Incidentally, the gate function optimization processing unit 113 (more specifically, the valid branch node selection unit 113-1 and the branch parameter optimization parallel processing unit 113-2) is implemented by a CPU of a computer that operates according to a program (estimation program of the hierarchical latent variable mode).

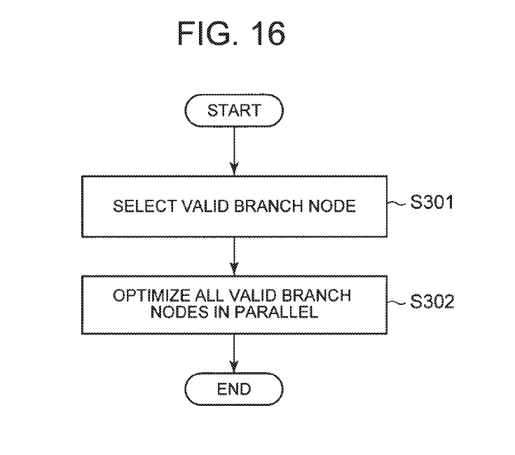

Next, an operation of the gate function optimization processing unit 113 of this exemplary embodiment will be described. FIG. 16 is a flowchart illustrating an operation example of the gate function optimization processing unit 113 according to at least one exemplary embodiment. First, the valid branch node selection unit 113-1 selects all the valid branch nodes (step S301). Next, the branch parameter optimization parallel processing unit 113-2 optimizes all the valid branch nodes in parallel (step S302), and ends the process.

As above, according to this exemplary embodiment, the valid branch node selection unit 113-1 selects the valid branch node from nodes of the hierarchical latent structure, and the branch parameter optimization parallel processing unit 113-2 optimizes the gate function model based on the latent variable variational probability of the valid branch node. At this time, the branch parameter optimization parallel processing unit 113-2 processes for optimization of the respective branch parameters relating to the valid branch node in parallel. Accordingly, it is possible to perform the optimization process of the gate function in parallel, and thus, the more rapid model estimation becomes possible in addition to the effects of the above-described exemplary embodiments.

### Fourth Exemplary Embodiment

Next, a fourth exemplary embodiment of the present invention will be described.

A deterioration estimation system according to the fourth exemplary embodiment performs maintenance management of equipment based on estimation of deterioration of the equipment serving as a target. To be specific, the deterioration estimation system determines a maintenance period of equipment based on estimation of deterioration of the equipment. Incidentally, the equipment serving as the target is not limited to a machine or a facility used at the time of constructing social infrastructure for example. Examples of the facility serving as the target include parts or wirings provided in the machine or the facility, a road, communication network, and the like to construct the infrastructure.

Incidentally, a description will be given regarding a case in which deterioration estimation is performed for each part provided in target equipment in this exemplary embodiment. A deterioration estimation device 800, included in the deterioration estimation system according to the fourth exemplary embodiment, is an example of a maintenance period determination device.

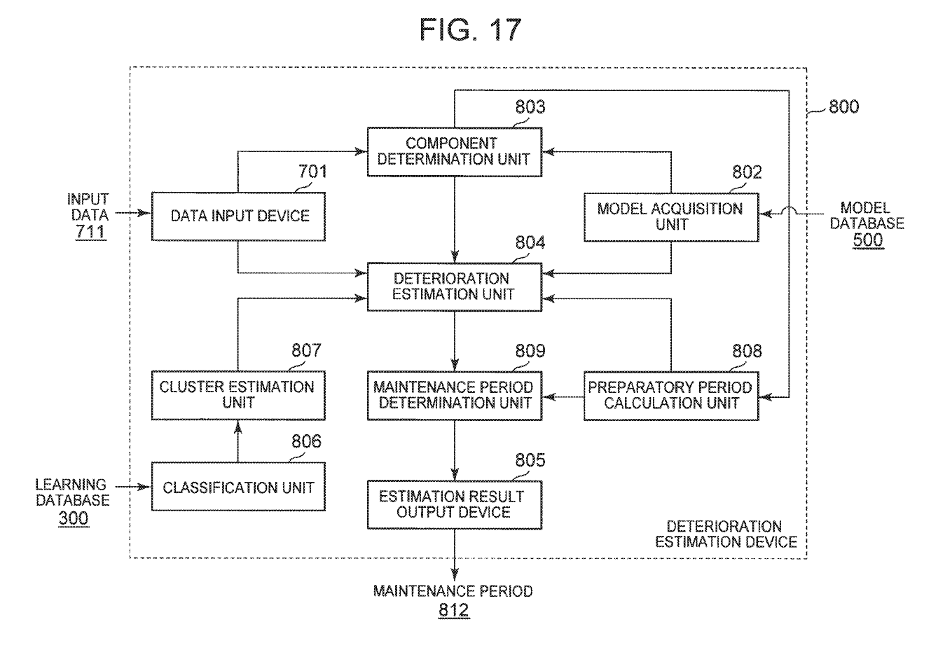

FIG. 17 is a block diagram illustrating a configuration example of the deterioration estimation device according to at least one exemplary embodiment. The deterioration estimation system according to this exemplary embodiment is obtained by replacing the deterioration estimation device 700 with the deterioration estimation device 800 as compared to the deterioration estimation system 10. The deterioration estimation device 800 is an example of the deterioration estimation device.

The deterioration estimation device 800 is further provided with a classification unit 806, a cluster estimation unit 807, a preparatory period calculation unit 808, and a maintenance period determination unit 809 in addition to the configuration in the first exemplary embodiment. In addition, the deterioration estimation device 800 is different from that of the first exemplary embodiment in terms of each operation of a model acquisition unit 802, a component determination unit 803, a deterioration estimation unit 804, and an estimation result output device 805.

The classification unit 806 acquires equipment attributes of a plurality of equipment from the equipment attribute table of the learning database 300, and classifies the respective equipment into clusters based on the equipment attributes. The classification unit 806 performs the classification of the cluster using, for example, the k-means algorithm and various algorithms of hierarchical clustering. The k-means algorithm is an algorithm that performs clustering by classifying respective individuals into randomly generated clusters and repetitively executing the process of updating each center of the clusters based on each information of the classified individuals.

The cluster estimation unit 807 estimates any cluster to which equipment serving as a target of estimation belongs based on a result of the classification obtained by the classification unit 806.

The preparatory period calculation unit 808 calculates a preparatory period of a maintenance period based on an estimation error of the component determined by the component determination unit 803. Herein, the preparatory period is a period indicating a width of a maintenance period.

The maintenance period determination unit 809 determines a maintenance period based on deterioration of the target equipment estimated by the deterioration estimation unit 804 and the preparatory period calculated by the preparatory period calculation unit 808. For example, a period at which replacement of deteriorated parts, supplement of consumables, removal of foreign matters, and the like are required is indicated as the maintenance period.

An operation of the deterioration estimation system according to this exemplary embodiment will be described.

First, the hierarchical latent variable model estimation device 100 estimates a gate function and a component, configured to estimate of deterioration of a target part in equipment, for each target equipment or for each target part. In this exemplary embodiment, the hierarchical latent variable model estimation device 100 estimates the gate function and the component for each part. In this exemplary embodiment, the hierarchical latent variable model estimation device 100 calculates the gate function and the component according to the method described in the first exemplary embodiment. Incidentally, the hierarchical latent variable model estimation device 100 may calculate a gate function and a component using the method described in the second exemplary embodiment or the method described in the third exemplary embodiment in another exemplary embodiment.

In this exemplary embodiment, the hierarchical latent variable model estimation device 100 calculates a dispersion of the estimation error for each estimated component. Examples of the dispersion of the estimation error include a standard deviation, a variance, and a range of the estimation error, a standard deviation, a variance, and a range of an estimation error rate, and the like.

The hierarchical latent variable model estimation device 100 records the gate function, the component, and the dispersion of the estimation error of each component thus estimated in the model database 500.

When the gate function, the component, and the dispersion of the estimation error of each component are recorded in the model database 500, the deterioration estimation device 800 starts the deterioration estimation.

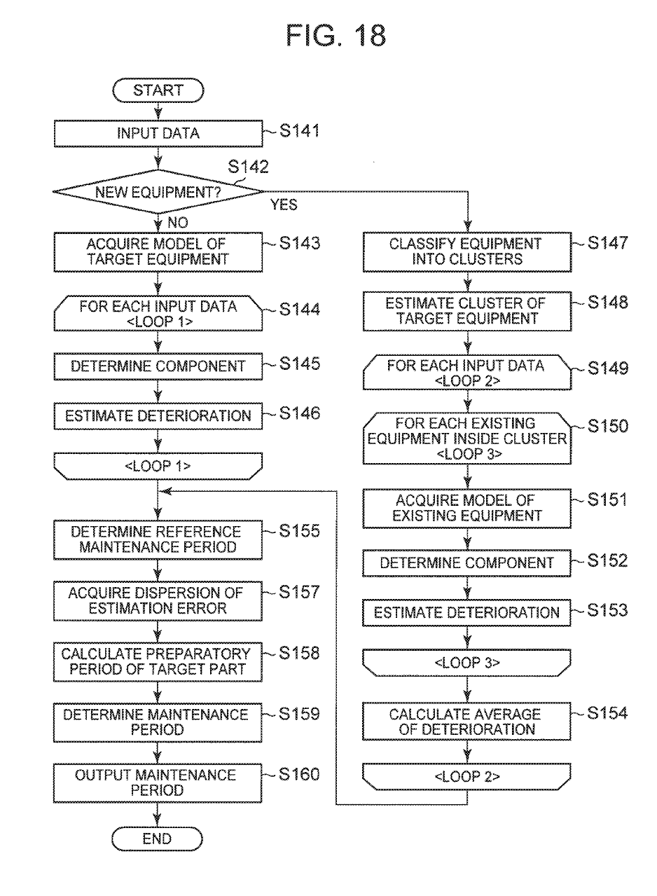

FIG. 18 is a flowchart illustrating an operation example of the deterioration estimation device according to at least one exemplary embodiment.

The data input device 701 of the deterioration estimation device 800 inputs the input data 711 (step S141). To be specific, the data input device 701 inputs an equipment attribute of the target equipment, a part attribute of a part provided in the target equipment, and observation information obtained by observing a performance and a state of the part as the input data 711.

Next, the model acquisition unit 802 determines whether the target equipment is new equipment (step S142). For example, the model acquisition unit 802 determines that the target equipment is the new equipment when any of a gate function, a component, and a dispersion of an estimation error is not recorded regarding the target equipment in the model database 500. In addition, for example, the model acquisition unit 802 determines that the target equipment is the new equipment when there is no measured value inside a part table associated with an equipment ID of an equipment table of the learning database 300.

When it is determined that the target equipment is existing equipment (step S142: NO), the model acquisition unit 802 acquires a gate function, a component, and a dispersion of an estimation error regarding the target equipment from the model database 500 (step S143). Next, the deterioration estimation device 800 selects the input data 711 one by one, and executes the following processes in step S145 and step S146 for the selected input data 711 (step S144). In other words, the deterioration estimation device 800 executes the processes in step S145 and step S146 for each part provided in the target equipment.

First, the component determination unit 803 determines the component to be used for deterioration estimation by tracing a path from the root node to the lowest-level node in the hierarchical latent structure based on a gate function acquired by the model acquisition unit 802 (step S145). When the component determination unit 803 determines the component to be used for the deterioration estimation, the deterioration estimation unit 804 estimates the deterioration of an object by substituting the input data 711 selected in step S144 into the component (step S146).

On the other hand, when the model acquisition unit 802 determines that the target equipment is the new equipment (step S142: YES), the classification unit 806 acquires the equipment attributes of the plurality of equipment from the equipment attribute table of the learning database 300, and classifies the equipment into the cluster based on the equipment attribute (step S147). Incidentally, examples of a classification target according to the classification unit 806 include the target equipment. Next, the cluster estimation unit 807 estimates any cluster to which the target equipment belongs based on a result of the classification obtained by the classification unit 806 (step S148).

Next, the deterioration estimation device 800 selects the input data 711 one by one, and executes the following processes in step S150 to step S154 for the selected input data 711 (step S149).

The deterioration estimation device 800 selects the existing equipment that belongs to the cluster estimated by the cluster estimation unit 807 one by one, and executes the following processes in step S151 to step S153 for the existing equipment (step S150). First, the model acquisition unit 802 acquires a gate function, a component and a dispersion of an estimation error for the existing equipment, which is selected in step S143, from the model database 500 (step S151).

Next, the component determination unit 803 determines the component to be used for deterioration estimation by tracing a path from the root node to the lowest-level node in the hierarchical latent structure based on a gate function acquired by the model acquisition unit 802 (step S152). When the component determination unit 803 determines the component to be used for the deterioration estimation, the deterioration estimation unit 804 estimates the deterioration of an object by substituting the input data 711 selected in step S151 into the component (step S153).

When the processes in step S151 to step S153 are executed for the entire existing equipment inside the same cluster as the target equipment, the deterioration estimation unit 804 calculates an average value of deterioration in each equipment of the part for each of the target part as a deterioration estimation value of the target part in the target equipment (step S154). Accordingly, the deterioration estimation device 800 can estimate the deterioration of the target part regarding new equipment for which past deterioration information is not stored.

When the deterioration estimation device 800 executes the processes in step S145 and step S146 or the processes in step S149 to step S154 for the entire input data 711, the maintenance period determination unit 809 determines a maintenance period to be set as a reference of the object (step S155). To be specific, the maintenance period determination unit 809 estimates a period at which deterioration of the target part is below a reference to be set for each part, and determines this period as the maintenance period serving as the reference.

The preparatory period calculation unit 808 acquires the dispersion of the estimation error of the component, determined by the component determination unit 803 in step S145 or step S152, from the model acquisition unit 802 (step S157). Next, the preparatory period calculation unit 808 calculates the preparatory period of the maintenance period of the target part based on the acquired dispersion of the estimation error (step S158). For example, the preparatory period calculation unit 808 can calculate the preparatory period by multiplying a total sum of standard deviations by a predetermined coefficient when the dispersion of the estimation error is a standard deviation of the estimation error. In addition, when the dispersion of the estimation error is a standard deviation of an estimation error rate, for example, the preparatory period calculation unit 808 can calculate the preparatory period by multiplying a period until the deterioration of the target part becomes below the reference set in advance by an average value of the standard deviations and a predetermined coefficient.

Further, the maintenance period determination unit 809 determines the maintenance period of the target part by considering the preparatory period calculated in step S158 with the period calculated in step S155 (for example, adding or subtracting the time to or from the period) (step S159). The estimation result output device 805 outputs a maintenance period 812 determined by the maintenance period determination unit 809 (step S160). In this manner, the deterioration estimation device 800 can determine the appropriate maintenance period using the appropriate component through the gate function.

As above, the deterioration estimation device 800 of this exemplary embodiment can accurately estimate the deterioration regardless of whether the target equipment is the new equipment or the existing equipment, and further, determine the appropriate maintenance period.

In addition, this exemplary embodiment has been described regarding the case in which the deterioration estimation unit 804 calculates the average value of estimated deterioration of the existing equipment of the same cluster as the target equipment in the case of estimating the deterioration of the target equipment which is the new equipment, but the invention is not limited thereto. For example, the deterioration estimation unit 804 may calculate an average value by performing weighting depending on a degree of similarity between the target equipment and the existing equipment or perform calculation using other representative values such as a middle value and a maximum value in other exemplary embodiments.

In addition, this exemplary embodiment has been described regarding the case in which the deterioration is estimated based on the model of the existing equipment when the target equipment is the new equipment, but the invention is not limited thereto. For example, deterioration may be estimated based on the model of the existing equipment of the same cluster as the target equipment for a part to be newly provided in the target equipment even when the target equipment is the existing equipment in other exemplary embodiments.

In addition, this exemplary embodiment has been described regarding the case in which the deterioration estimation device 800 sets the period obtained by adding or subtracting the preparatory period to or from the reference maintenance period as the maintenance period to prevent the maintenance period from being delayed, but the invention is not limited thereto. For example, the deterioration estimation device 800 may set a period obtained by shortening by the amount corresponding to the dispersion of the estimation error from the reference the maintenance period may be set as the maintenance period in order to suppress excessive maintenance in other exemplary embodiments.

### Fifth Exemplary Embodiment

Next, a fifth exemplary embodiment of the deterioration estimation system will be described.

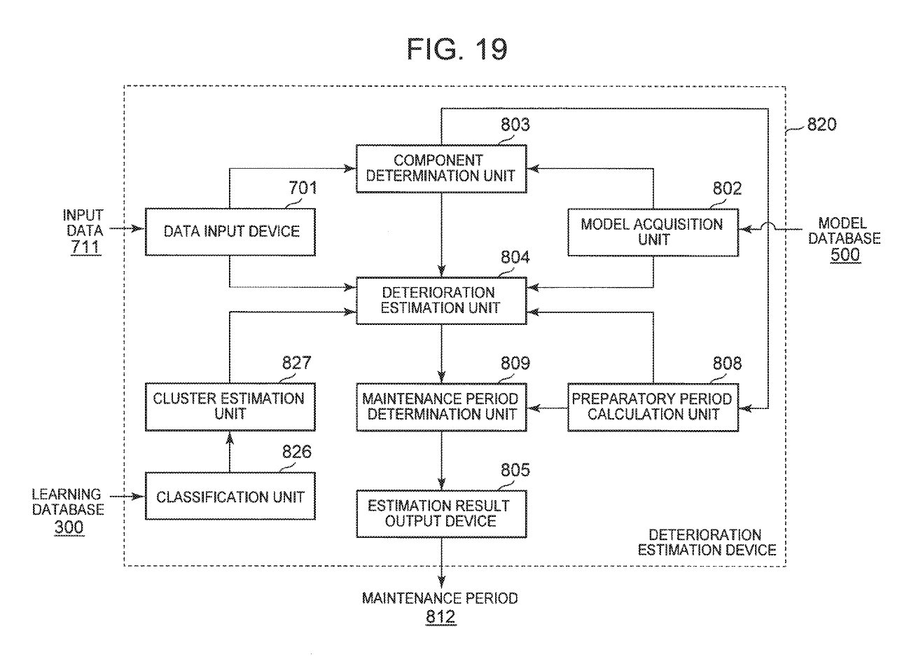

FIG. 19 is a block diagram illustrating a configuration example of the deterioration estimation device according to at least one exemplary embodiment. The deterioration estimation system according to this exemplary embodiment is obtained by replacing the deterioration estimation device 800 with a deterioration estimation device 820 as compared to the deterioration estimation system according to the fourth exemplary embodiment. The classification unit 806 is replaced by a classification unit 826, and the cluster estimation unit 807 is replaced by a cluster estimation unit 827 in the deterioration estimation device 820 as compared to the deterioration estimation device 800.

The classification unit 826 classifies the existing equipment into a plurality of clusters based on information relating to deterioration. The classification unit 826 performs the classification of the cluster using the k-means algorithm and various algorithms of hierarchical clustering. For example, the classification unit 826 classifies the existing equipment into the cluster based on a coefficient of the component acquired by the model acquisition unit 802 or the like. Accordingly, a variation in tendency of the period until the maintenance decreases for each equipment in the same cluster.

The cluster estimation unit 827 estimates a relationship between the cluster classified by the classification unit 826 and an equipment attribute. In other words, the cluster estimation unit 827 creates a function in which the equipment attribute is set as an explanatory variable and the cluster is set as an objective variable. The estimation can be performed according to supervised learning such as the c4.5 decision tree algorithm or a support vector machine. The cluster estimation unit 827 estimates any cluster to which the new equipment belongs based on the equipment attribute of the new equipment and the estimated relationship.

Accordingly, the deterioration estimation device 820 of this exemplary embodiment can estimate the deterioration of the target part based on the cluster of the existing equipment that is estimated to have a similar tendency of the period until maintenance as the new equipment.

### Sixth Exemplary Embodiment

Next, a sixth exemplary embodiment of the deterioration estimation system will be described. A deterioration estimation system of this exemplary embodiment has the same configuration as that in the fourth exemplary embodiment. Meanwhile, the estimation result output device 805 of this exemplary embodiment is different from that in the sixth exemplary embodiment in terms of outputting information other than the maintenance period. That is, it is possible to say that the estimation result output device 805 of this exemplary embodiment has a function of presenting a factor of deterioration to a user.

Since a component is a value indicating a weight applied to each explanatory variable, the component used in deterioration estimation can be expressed by a linear expression as illustrated in Formula B, for example, as below.

y=a₀+a₁x₁+a₂x₂+ . . . +aₙxₙ (Formula B)

Herein, y is an objective variable indicating deterioration of an object, and xᵢ is an explanatory variable. In addition, aᵢ indicates a weight with respect to each explanatory variable xᵢ.

The estimation result output device 805 may output content of an explanatory variable having more influence on the deterioration of the object among the explanatory variables to be used for the deterioration estimation. The estimation result output device 805 may output an explanatory variable having a larger weight value, for example. In addition, the estimation result output device 805 may adjust a weight value in accordance with a range that each explanatory variable can take, and output an explanatory variable having a larger adjusted weight value.

In this exemplary embodiment, an estimation formula of the objective variable obtained by the component determination unit 803 can be expressed in the format of, for example, Formula B illustrated as above, and thus, it is highly superior from a viewpoint of easiness of interpretation as the estimation formula is not a so-called black-boxed expression. Accordingly, it is possible to present the explanatory variable affected by the deterioration of the object with the low cost.

<Basic Configuration>

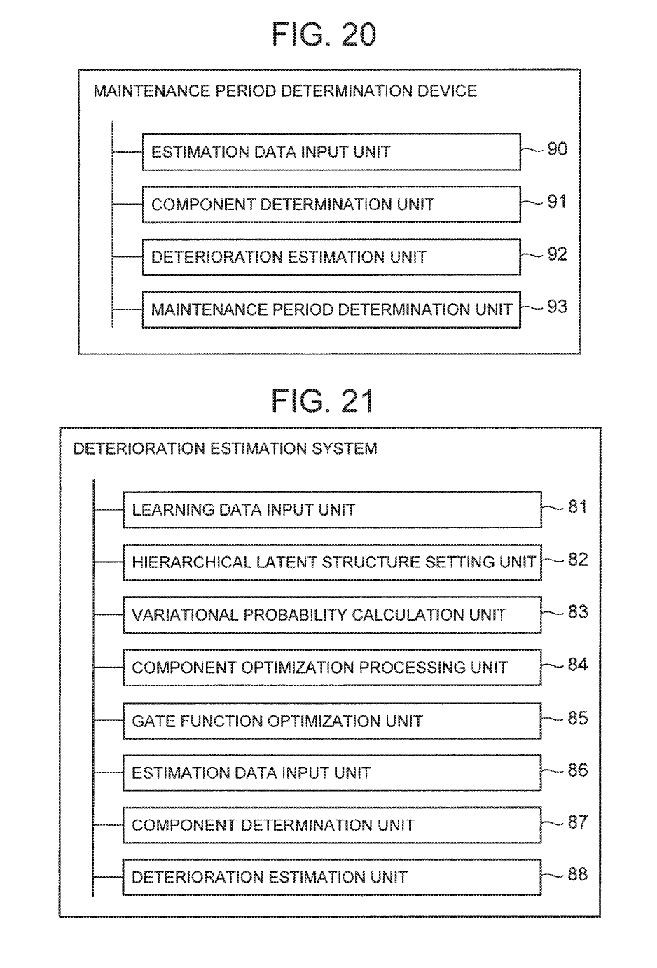

Next, a basic configuration of a maintenance period determination device will be described. FIG. 20 is a block diagram illustrating a basic configuration of the maintenance period determination device.

The maintenance period determination device is provided with an estimation data input unit 90, a component determination unit 91, a deterioration estimation unit 92, and a maintenance period determination unit 93.

The estimation data input unit 90 inputs estimation data including one or more explanatory variables which are information that may influence deterioration of an object. Examples of the estimation data input unit 90 may include the data input device 701.

The component determination unit 91 determines a component to be used for estimation of deterioration of the object based on a hierarchical latent structure, which is a structure in which latent variables are represented by a tree structure and each of the components representing a probability model is assigned to each node at the lowest level of the tree structure, a gate function to determine a branch direction at each node of the hierarchical latent structure, and the estimation data. Examples of the component determination unit 91 may include the component determination unit 803.

The deterioration estimation unit 92 estimates the deterioration of the object based on the component determined by the component determination unit 91 and the estimation data. Examples of the deterioration estimation unit 92 may include the deterioration estimation unit 804.

The maintenance period determination unit 93 determines a maintenance period of an object by adding or subtracting a period corresponding to a dispersion of an estimation error of the component determined by the component determination unit 91 to or from a period at which it is estimated such that the deterioration of the object is below a reference set in advance using the estimation performed by the deterioration estimation unit 92. Examples of the maintenance period determination unit 93 may include the maintenance period determination unit 809.

Through such a configuration, the maintenance period determination device can determine the appropriate maintenance period using the appropriate component through the gate function.

Next, a basic configuration of the deterioration estimation system will be described. FIG. 21 is a block diagram illustrating a basic configuration of the deterioration estimation system. The deterioration estimation system is provided with: a learning data input unit 81 (for example, the data input device 101) that inputs learning data including a plurality of combinations between an objective variable representing deterioration of an object and one or more explanatory variables which are information that may influence the deterioration of the object; a hierarchical latent structure setting unit 82 (for example, the hierarchical latent structure setting unit 102) that sets a hierarchical latent structure as a structure in which latent variables are represented by a tree structure and each of the components representing a probability model is assigned to each node at the lowest level of the tree structure; a variational probability calculation unit 83 (the hierarchical latent variable variational probability calculation processing unit 104) that calculates a variational probability of a path latent variable which is the latent variable included in a path obtained by connecting a root node to a target node in the hierarchical latent structure based on the learning data input from the learning data input unit 81 and the component; a component optimization processing unit 84 (for example, the component optimization processing unit 105) that optimizes the component with respect to the calculated variational probability based on the learning data input from the learning data input unit 81; a gate function optimization unit 85 (for example, the gate function optimization processing unit 106) that optimizes a gate function model, which is a model to determine a branch direction in accordance with the explanatory variable at each node of the hierarchical latent structure, based on a latent variable variational probability of the node; an estimation data input unit 86 (for example, the data input device 701) that inputs one or more of the explanatory variables as estimation data; a component determination unit 87 (for example, the component determination unit 703) that determines a component to be used for estimation of the deterioration of the object among the components optimized by the component optimization processing unit 84 based on the gate function optimized by the gate function optimization unit 85 and the estimation data; and a deterioration estimation unit 88 (for example, the deterioration estimation unit 704) that estimates the deterioration of the object based on the component determined by the component determination unit 87 and the estimation data.

Through such a configuration, it is possible to estimate the deterioration of the object while suppressing cost.

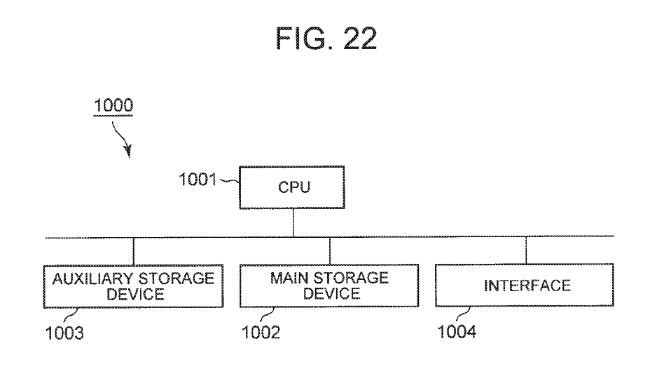

FIG. 22 is a schematic block diagram illustrating a configuration of a computer according to at least one exemplary embodiment.

A computer 1000 is provided with a CPU 1001, a main storage device 1002, an auxiliary storage device 1003, and an interface 1004.

Each of the above-described hierarchical latent variable model estimation devices and deterioration estimation devices is implemented in the computer 1000. Incidentally, the computer 1000 equipped with the hierarchical latent variable model estimation device may be different from the computer 1000 equipped with the deterioration estimation device. Further, the above-described operation of each processing unit is stored in the auxiliary storage device 1003 in a format of a program (a hierarchical latent variable model estimation program or a deterioration estimation program). The CPU 1001 reads out the program from the auxiliary storage device 1003 and expands it into the main storage device 1002 to execute the above-described processes according to the program.

Incidentally, the auxiliary storage device 1003 is an example of a non-transitory tangible medium in at least one exemplary embodiment. Other examples of the non-transitory tangible medium may include a magnetic disk, a magneto-optical disk, a CD-ROM, a DVD-ROM, a semiconductor memory, and the like which are connected via the interface 1004. In addition, when the program is distributed to the computer 1000 via a communication line, the computer 1000 may expand this program into the main storage device 1002 and execute the above-described processes in response to the distribution.

In addition, the program may be configured to implement some of the above-described functions. Further, the program may serve as one which implements the above-described functions in combination with other programs that have been already stored in the auxiliary storage device 1003, that is, a so-called difference file (difference program).

As above, the invention of the present application has been described with reference to the exemplary embodiments and examples, but the invention of the present application is not limited to the above-described exemplary embodiments and examples. Various modifications that can be understood by the person skilled in the art can be made within a scope of the invention of the present application regarding the configuration and the details of the invention of the present application.

This application claims priority based on U.S. Provisional Application No. 61/985,237 filed on Apr. 28, 2014, the disclosure of which is incorporated herein by reference in its entirety.

### REFERENCE SIGNS LIST

10 Deterioration estimation system
100 Hierarchical latent variable model estimation device
300 Learning database
500 Model database
800, 820 Deterioration estimation device
802 Model acquisition unit
803 Component determination unit
804 Deterioration estimation unit
806, 826 Classification unit
807, 827 Cluster estimation unit
808 Preparatory period calculation unit
809 Maintenance period determination unit

1. A maintenance period determination device comprising:
hardware including a processor;
an estimation data input unit implemented at least by the hardware and that inputs estimation data including one or more explanatory variables which are information that has a possibility of influencing deterioration of an object;
a component determination unit implemented at least by the hardware and that determines a component to be used for estimation of the deterioration of the object based on a hierarchical latent structure, which is a structure in which latent variables are represented by a tree structure and each of the components representing a probability model is assigned to each node at a lowest level of the tree structure, a gate function to determine a branch direction at each node of the hierarchical latent structure, and the estimation data;
a deterioration estimation unit implemented at least by the hardware and that estimates the deterioration of the object based on the component determined by the component determination unit and the estimation data; and
a maintenance period determination unit implemented at least by the hardware and that determines a maintenance period of the object by adding or subtracting a period corresponding to a dispersion of an estimation error of the component, determined by the component determination unit, to or from a period at which it is estimated such that the deterioration of the object is below a reference set in advance using the estimation performed by the deterioration estimation unit.

2. The maintenance period determination device according to claim 1, further comprising
a preparatory period calculation unit implemented at least by the hardware and that calculates a preparatory period indicating a width of the maintenance period,
wherein the deterioration estimation unit estimates the deterioration of the object using the component determined by the component determination unit and the estimation data, and
the preparatory period calculation unit calculates the preparatory period corresponding to the dispersion of the estimation error of each of the components used for the estimation of deterioration by the deterioration estimation unit.

3. The maintenance period determination device according to claim 1, wherein
the component determination unit determines a component indicating a weight applied to each of the explanatory variables, and
the deterioration estimation unit estimates the deterioration of the object using an objective variable which is represented by a total sum of explanatory variables each of which is multiplied by the weight indicated by the component.

4. The maintenance period determination device according to claim 1, further comprising
a factor presentation unit implemented at least by the hardware and that outputs content of an explanatory variable having more influence on the deterioration of the object among the explanatory variables used for the deterioration estimation.

5. The maintenance period determination device according to claim 4, wherein
the factor presentation unit determines the explanatory variable having more influence on the deterioration of the object depending on the weight applied to each of the explanatory variables used to represent the objective variable.

6. A maintenance period determination method comprising:
inputting estimation data including one or more explanatory variables which are information that has a possibility of influencing deterioration of an object;
determining a component to be used for estimation of the deterioration of the object based on a hierarchical latent structure, which is a structure in which latent variables are represented by a tree structure and each of the components representing a probability model is assigned to each node at a lowest level of the tree structure, a gate function to determine a branch direction at each node of the hierarchical latent structure, and the estimation data;
estimating the deterioration of the object based on the determined component and the estimation data; and
determining a maintenance period of the object by adding or subtracting a period corresponding to a dispersion of an estimation error of the determined component to or from a period at which it is estimated such that the deterioration of the object is below a reference set in advance.

7. A non-transitory computer readable information recording medium storing a maintenance period determination program, when executed by a processor, that performs a method for:
inputting estimation data including one or more explanatory variables which are information that has a possibility of influencing deterioration of an object;
determining a component to be used for estimation of the deterioration of the object based on a hierarchical latent structure, which is a structure in which latent variables are represented by a tree structure and each of the components representing a probability model is assigned to each node at a lowest level of the tree structure, a gate function to determine a branch direction at each node of the hierarchical latent structure, and the estimation data;
estimating the deterioration of the object based on the determined component and the estimation data; and
determining a maintenance period of the object by adding or subtracting a period corresponding to a dispersion of an estimation error of the determined component to or from a period at which it is estimated such that the deterioration of the object is below a reference set in advance.

8. A deterioration estimation system comprising:
hardware including a processor;
a learning data input unit implemented at least by the hardware and that inputs learning data including a plurality of combinations between an objective variable representing deterioration of an object and one or more explanatory variables which are information that has a possibility of influencing the deterioration of the object;
a hierarchical latent structure setting unit implemented at least by the hardware and that sets a hierarchical latent structure as a structure in which latent variables are represented by a tree structure and each of the components representing a probability model is assigned to each node at the lowest level of the tree structure;
a variational probability calculation unit implemented at least by the hardware and that calculates a variational probability of a path latent variable which is the latent variable included in a path obtained by connecting a root node to a target node in the hierarchical latent structure based on the learning data input from the learning data input unit and the component;
a component optimization processing unit implemented at least by the hardware and that optimizes the component with respect to the calculated variational probability based on the learning data input from the learning data input unit;
a gate function optimization unit implemented at least by the hardware and that optimizes a gate function model, which is a model to determine a branch direction in accordance with the explanatory variable at each node of the hierarchical latent structure, based on a latent variable variational probability of the node;
an estimation data input unit implemented at least by the hardware and that inputs one or more of the explanatory variables as estimation data;
a component determination unit implemented at least by the hardware and that determines a component to be used for estimation of the deterioration of the object among the components optimized by the component optimization processing unit based on the gate function optimized by the gate function optimization unit and the estimation data; and
a deterioration estimation unit implemented at least by the hardware and that estimates the deterioration of the object based on the component determined by the component determination unit and the estimation data.

9. A deterioration estimation method comprising:
inputting learning data including a plurality of combinations between an objective variable representing deterioration of an object and one or more explanatory variables which are information that has a possibility of influencing the deterioration of the object;
setting a hierarchical latent structure as a structure in which latent variables are represented by a tree structure and each of the components representing a probability model is assigned to each node at the lowest level of the tree structure;
calculating a variational probability of a path latent variable which is the latent variable included in a path obtained by connecting a root node to a target node in the hierarchical latent structure based on the input learning data and the component;
optimizing the component with respect to the calculated variational probability based on the input learning data;
optimizing a gate function model, which is a model to determine a branch direction in accordance with the explanatory variable at each node of the hierarchical latent structure, based on a latent variable variational probability of the node;
inputting one or more of the explanatory variables as estimation data;
determining a component to be used for estimation of the deterioration of the object among the optimized components based on the optimized gate function and the estimation data; and
estimating the deterioration of the object based on the determined component and the estimation data.

10. A non-transitory computer-readable recording medium in which a deterioration estimation program is recorded,
the deterioration estimation program causing a computer to execute:
a learning data input process that inputs learning data including a plurality of combinations between an objective variable representing deterioration of an object and one or more explanatory variables which are information that has a possibility of influencing the deterioration of the object;
a hierarchical latent structure setting process that sets a hierarchical latent structure as a structure in which latent variables are represented by a tree structure and each of the components representing a probability model is assigned to each node at the lowest level of the tree structure;
a variational probability calculation process that calculates a variational probability of a path latent variable which is the latent variable included in a path obtained by connecting a root node to a target node in the hierarchical latent structure based on the learning data input in the learning data input process and the component;
a component optimization process that optimizes the component with respect to the calculated variational probability based on the learning data input in the learning data input process;
a gate function optimization process that optimizes a gate function model, which is a model to determine a branch direction in accordance with the explanatory variable at each node of the hierarchical latent structure, based on a latent variable variational probability of the node;
an estimation data input process that inputs one or more of the explanatory variables as estimation data;
a component determination process that determines a component to be used for estimation of the deterioration of the object among the components optimized in the component optimization process based on the gate function optimized in the gate function optimization process and the estimation data; and
a deterioration estimation process that estimates the deterioration of the object based on the component determined in the component determination process and the estimation data.
